(19) United States
(12) Patent Application Publication
(10) Pub. No.: US 2013/0040846 A1
(43) Pub. Date: Feb. 14, 2013

(54) Signatures for Kidney Aging

(71) Applicants: Heather Elizabeth Wheeler, Chicago, IL (US); Stuart K. Kim, Stanford, CA (US)

(72) Inventors: Heather Elizabeth Wheeler, Chicago, IL (US); Stuart K. Kim, Stanford, CA (US)

(21) Appl. No.: 13/580,120

(22) PCT Filed: Feb. 23, 2011
(86) PCT No.: PCT/US11/25942

§ 371 Date: Oct. 29, 2012

Related U.S. Application Data
(60) Provisional application No. 61/338,894, filed on Feb. 24, 2010.

(51) Int. Cl. C40B 30/04; C40B 40/06

(52) U.S. Cl. 506/9; 506/16

(57) ABSTRACT

Sets of genes associated with aging in the kidney are identified herein, and methods of assessing the health and longevity of the kidney in a human subject are disclosed. Methods include obtaining a DNA sample from the subject and analyzing the sample for the occurrence of at least one single nucleotide polymorphism (SNP) in at least one gene that is identified herein as correlating with physiological aging of the kidney. Also disclosed are potential drug targets for improving the physiological health and lifespan of the kidney.

### GOVERNMENT SUPPORT

This invention was made with Government support under contract AG025941 awarded by the National Institutes of Health. The Government has certain rights in the invention.

### BACKGROUND OF THE INVENTION

The age at which physiological function begins to decline and the rate of that decline varies among individuals. The heritability of human longevity ranges from 0.23-0.26, but little is known about specific genes that affect the rate of aging or human lifespan. Candidate gene studies have found a few genes in which certain alleles are enriched in centenarians versus the normal population, including APOC3 (GeneID 345), IGF1R (GeneID 3480) and FOX03A (GeneID 2309). These alleles may promote better health and contribute toward extended lifespan.

The kidney shows a quantifiable decline in function with age. With age, the kidney gets smaller, particularly in the cortex, and kidney function begins to measurably decline. Overall renal function can be measured by assessing the glomerular filtration rate (GFR), which-is the rate at which blood is filtered through the glomeruli. The glomeruli are ball-shaped structures in the kidney composed of capillary blood vessels actively involved in the filtration of the blood to form urine. The major aging phenotype in the kidney is a 25% decline in GFR starting at age 40.

However, there is significant variation between individuals in the rate of kidney aging. In one study, one third of individuals showed no decrease in GFR measured over a 20 year period, whereas the remainder of the population showed a distinct decrease (Lindeman R D, Tobin J, Shock N W (1985), Longitudinal Studies on the rate of decline in renal function with age, J Am Geriat Soc 33:278-285). The heritability of GFR is estimated to be 0.40-0.46. In a genome-wide association study, single nucleotide polymorphisms (SNPs) in three gene regions (UMOD, GeneID 7369; SHROOM3, GeneID 57619; and GATMSPATA5L1, GeneIDs 2628 and 79029) were shown to associate with GFR (Kottgen A, Glazer N L, Dehghan A, Hwang S J, Katz R, et al. (2009) Multiple loci associated with indices of renal function and chronic kidney disease, Nat Genet, 41:712-717).

One method which can be used to identify genes that contribute to a disease phenotype is a genome-wide association study. However, in this method hundreds of thousands of SNPs are tested, which presents a significant obstacle to producing meaningful results. A powerful alternative to genome-wide association studies is genomic convergence, which selects candidate genes for a disease based on genome-wide expression studies. Differential gene expression between affected individuals and controls can indicate that a particular gene is functionally involved in disease pathogenesis. This approach was first used to identify genes associated with Parkinson's disease, schizophrenia, and Alzheimer's disease. With this method, DNA chips can be used to identify increases or decreases in gene expression in affected individuals as compared to controls. Identified SNPs in the genes with altered expression can be used as candidates for genetic association studies. Use of genomic convergence therefore increases the chance of identifying genes that contribute to the disease phenotype.

The identification of biomarkers for human aging are of great medical interest, particularly biomarkers that correlate with physiological age, and that are commonly regulated in human tissues such as the kidney. The present invention addresses this issue.

### SUMMARY OF THE INVENTION

Genes associated with aging in the human kidney are identified herein. In particular, specific SNPs are shown to be associated with kidney aging, as well as alterations in the promoter. Specific genes shown to be associated with kidney aging include MMP20, which shows decreased expression with age in multiple tissues, and in which polymorphisms are shown herein to be associated with aging. Also of interest are polymorphisms in the insulin-like growth factor 1 receptor. The presence of an SNP associated with aging in a genotype is indicative of a predisposition to aging of the kidney and other tissues. In addition to the specific SNPs provided herein, any SNP in linkage disequilibrium with the provided SNPs are useful in the assessment of kidney health and longevity.

In one embodiment of the invention, analysis of the signature for aging in a kidney sample is used in a method of diagnosing physiological age in a kidney. Knowledge of physiological age is useful in providing appropriate medical treatment and prevention, as many diseases are associated with physiological aging. The analysis is also useful in diagnosing the physiological age of tissues, e.g. the kidney, to evaluate the suitability of organs for transplantation.

Methods of analysis may include, without limitation, the use of a genomic convergence approach to find genes associated with aging in the kidney. Genome wide transcriptional profiling can be used to determine which genes change expression with age in kidney tissue (e.g., as measured by GFR). In some embodiments, a total expression method can be used to determine which of the identified age-regulated genes contain SNPs associated with expression level. In other embodiments, an allele-specific expression method can be used to determine which of the identified age-regulated genes contain SNPs associated with expression level. Identified genes that contain SNPs associated with kidney aging can be tested in any suitable population. The method of combining both expression and genotype data can be applied to any phenotype of interest to increase the ability to find genetic associations.

In other embodiments, methods of analysis can include establishing a training dataset, and comparing an unknown sample to the training dataset as test datasets, i.e. human age signatures. A training dataset may comprise, without limitation, expression analysis from cells known to be physiologically aged; cells from a non-aged source; cells of defined ages; and the like. The human age signature includes quantitative measure of a panel of expression products from one or more sets of genes, as described above. Expression products include mRNA and the encoded polypeptides. Other methods may utilize decision tree analysis, classification algorithms, regression analysis, and combinations thereof. In some embodiments, methods can include simple quantitative measure of expression products from a set of genes, and compared to a reference to determine differential expression.

In some embodiments, methods can include comparing a human age signature derived from quantitative measure of a panel of expression products from one or more sets of genes, and comparing said age signature with a control age signature, for example, a test dataset derived from cells of a defined age. A statistically significant match with a positive control or a statistically significant difference from a negative control can indicate the age in the sample.

In other embodiments, analysis of human age signatures (e.g., kidney age signatures) is used in a method of screening biologically active agents for efficacy in the treatment of aging. In such methods, cells of interest, e.g. kidney cells etc., which may be of a defined age, for example from an elderly cell source, from a non-aged source, etc. are contacted in culture or in vivo with a candidate agent, and the effect on expression of one or more of the markers, particularly a panel of markers, is determined. In another embodiment, analysis of differential expression is used in a method of following therapeutic regimens in patients. In a single time point or a time course, measurements of expression of one or more of the markers, e.g. a panel of markers, is determined when a patient has been exposed to a therapy, which may include a drug, combination of drugs, non-pharmacologic intervention, and the like.

### BRIEF DESCRIPTION OF THE DRAWINGS

FIGS. 1A and B: Total expression analysis. Genotypic associations with total expression level. (A) Boxplot of RPS26 expression according to genotype at the promoter SNP rs705704 (p=1.2×10⁻²⁰). The boxes define the interquartile range and the thick line is the median. Open dots are possible outliers. (B) Haploview linkage disequilibrium plot of RPS26 region. The SNP rs705704 is 274 by upstream of the RPS26 transcription start site. Values in boxes correspond to the pairwise r² LD values (darker boxes correspond to higher r² values) for the HapMap CEU population. rs705704 (red) is partially linked to two SNPs (black) previously shown to associate with RPS26 expression levels.

FIG. 2: Distribution of allele-specific expression. The white bars show the distribution of the allelic expression ratio for all heterozygotes that express the transcript of the 309 SNPs tested. The red bars show the distribution of the allelic expression ratio for heterozygotes that show allele-specific expression.

FIGS. 3A-C: Allele-specific expression analysis. The red lines indicate the 95% confidence interval surrounding the normalized genomic DNA allelic ratio. Each bar represents one heterozygous individual at the particular SNP listed. Individuals above the upper bound or below the lower bound display allele-specific expression. (A) Allele-specific expression was observed at SNP locus rs2245803 in the gene MMP20 in 11 of 12 heterozygotes tested. The A allele was expressed higher than the C allele in all the individuals displaying allele-specific expression. (B) Allele-specific expression was observed at SNP locus rs8643 in the gene TXNDC5 in 14 of 15 heterozygotes tested. The G allele was expressed higher than the A allele in all the individuals displaying allele-specific expression. (C) Boxplot of TXNDC5 total expression according to genotype at the 3′ UTR SNP rs8643 (p=1.2×10−4). The boxes define the interquartile range and the thick line is the median. Open dots are possible outliers.

FIGS. 4A and B: A SNP in MMP20 associates with a kidney aging phenotype. Loess smoothing lines through a scatter plot of creatinine clearance versus age stratified by genotype at rs1711437 in the BLSA (A) and InCHIANTI (B) populations (corrected p=0.01).

FIG. 5: Linkage disequilibrium pattern of MMP20. The two SNPs (green) for which we found significant associations with kidney aging are located in introns of MMP20. They are linked to each other and to two nonsynonymous SNPs (black) located in exon 6 of MMP20. Pairwise r² linkage disequilibrium values (darker boxes correspond to higher r²values) from the HapMap CEU population are displayed. These four SNPs are not linked to the SNP (red) in exon 1 that associated with expression level of the gene.

### DETAILED DESCRIPTION OF THE EMBODIMENTS

Age and related conditions are assessed with a gene expression test that determines the expression levels of a panel of genetic markers that provide for a human age signature, e.g., a human kidney age signature. Each age signature contains expression information for genes in at least one functional group that is identified herein as having an expression pattern that correlates with physiological aging of a kidney or other tissue of interest.

The human age signature provides diagnostic and prognostic methods, by detecting characteristic aging-related changes in expression of the indicated genes. The physiological age of an individual, organ, tissue, cell, etc. can be assessed by determining the human age signature. The methods also include screening for efficacy of therapeutic agents and methods; and the like. Early detection can be used to determine the probability of developing certain diseases, thereby allowing for intervention with appropriate preventive or protective measures.

Various techniques and reagents find use in the diagnostic methods of the present invention. In one embodiment of the invention, a tissue or cell samples, or samples derived from such tissues and cells are assayed for the presence of mRNA and/or polypeptides. Expression signatures typically utilize a detection method coupled with analysis of the results to determine if there is a statistically significant match with an age signature.

Chronological Age. The rate of aging is very species specific, where a human may be aged at about 50 years; and a rodent at about 2 years. In general terms, a natural progressive decline in body systems starts in early adulthood, but it becomes most evident several decades later. One arbitrary way to define old age more precisely in humans is to say that it begins at conventional retirement age, around about 60, around about 65 years of age. Another definition sets parameters for aging coincident with the loss of reproductive ability, which is around about age 45, more usually around about 50 in humans, but will, however, vary with the individual.

Physiological age. It has been found that individuals age at different rates, even within a species. Therefore chronological age may be at best imprecise and even misleading as to the extent of decline in function. It is therefore useful to use the methods of the present invention and to evaluate the physiological age of an individual, organ, tissue, cell, etc., rather than the chronological age. In addition to the patterns of gene expression reported herein, there are a number of indicia of physiological aging that are tissue specific.

For example, in kidney tissue, there is a general decline in the morphological appearance of the kidney with age, including a loss of glomerular structure and replacement of capillaries with fibrous tissue; collapse and atrophy of tubules; and thickening of the innermost layer of the arteriole wall due to the accumulation of hyaline material.

In some embodiments, a chronicity index is determined, which index is a quantitative estimate of the morphological appearance and physiological state of the tissue based on such criteria as discussed above.

Kidney age signature. Kidney age signatures comprise a dataset of expression information for genes identified herein as being correlated with physiological age. The term expression profile is used broadly to include a gene expression profile, e.g., an expression profile of mRNAs, or a proteomic expression profile, e.g., an expression profile of one or more different proteins. Profiles may be generated by any convenient means for quantitation, e.g. quantitative hybridization of mRNA, labeled mRNA, amplified mRNA, cRNA, etc., quantitative PCR, ELISA for protein quantitation, antibody arrays, and the like.

Each age signature will include expression information from at least one functional group for the age signature of interest and may include information from two or three functional groups. Functional groups specific for the human signature for kidney aging include maintenance of epithelial polarity, (increase expression with aging); and specific transcription factors and signaling pathway components.

Within a functional group, quantitative information is obtained from a sufficient number of genes to provide statistically significant information. Usually expression information from at least about 5 genes in a group is obtained, and the signature may include expression information from about 10, 15, 20, 25, 30 or more genes.

The expression profile may be generated from a biological sample using any convenient protocol. Samples can be obtained from the tissues or fluids of an individual, as well as from organs, tissues, cell cultures or tissue homogenates, etc. For example, samples can be obtained from whole blood, tissue biopsy, serum, etc. Also included in the term are derivatives and fractions of such cells and fluids. Where cells are analyzed, the number of cells in a sample can be at least about 10², at least 10³, and may be about 10⁴ or more. The cells may be dissociated, in the case of solid tissues, or tissue sections may be analyzed. Alternatively a lysate of the cells may be prepared.

Following obtainment of the expression profile from the sample being assayed, the expression profile is compared with a reference or control profile to make an assessment regarding the physiological age of the cell or tissue from which the sample was obtained/derived. Typically a comparison is made with a signature from a sample of known physiological age, e.g. an aged sample, a young sample, and the like. Usually for diagnostic or prognostic methods, a determined value or test value is statistically compared against a reference or baseline value.

In certain embodiments, the obtained signature is compared to a single reference/control profile to obtain information regarding the phenotype of the cell/tissue being assayed. In other embodiments, the obtained signature is compared to two or more different reference/control profiles to obtain more in depth information regarding the phenotype of the assayed cell/tissue. For example, the obtained expression profile may be compared to a positive and negative reference profile to obtain confirmed information regarding whether the cell/tissue has the phenotype of interest.

The difference values, i.e. the difference in expression with age, may be performed using any convenient methodology, where a variety of methodologies are known to those of skill in the array art, e.g., by comparing digital images of the expression profiles, by comparing databases of expression data, etc. Patents describing ways of comparing expression profiles include, but are not limited to, U.S. Pat. Nos. 6,308,170 and 6,228,575, the disclosures of which are herein incorporated by reference. Methods of comparing expression profiles are also described above. A statistical analysis step is then performed to obtain the weighted contribution of the set of predictive genes.

Genomic Convergence. In some embodiments, genomic convergence is used to select candidate genes for a disease (e.g., physiologic aging of the kidney) based on genome-wide expression studies. Genome wide transcriptional profiling can be used to determine which genes change expression with age in kidney tissue (e.g., as measured by glomerular filtration rate (GFR)). Differential gene expression between affected individuals and controls can indicate that the gene is functionally involved in disease pathogenesis. In some embodiments, a total expression method can be used to determine which of the identified age-regulated genes contain SNPs associated with expression level. In other embodiments, an allele-specific expression method can be used to determine which of the identified age-regulated genes contain SNPs associated with expression level. In some embodiments, DNA chips can be used to identify increases or decreases in gene expression in affected individuals as compared to controls. Identified single nucleotide polymorphisms (SNPs) in the genes with altered expression can be used as candidates for genetic association studies. Use of genomic convergence can increase the chance of identifying genes that contribute to the disease phenotype.

Diagnostic Algorithms. An algorithm that combines the results of multiple expression level determinations that will discriminate robustly between aged and non-aged tissues or cells, and controls for confounding variables and evaluating potential interactions is used for diagnostic purposes.

In such an algorithm, an age dthaset is obtained. The dataset comprises quantitative data for a human age signature as described above.

In order to identify profiles that are indicative of a sample age, a statistical test will provide a confidence level for a change in the biomarkers between the test and control profiles to be considered significant. The raw data may be initially analyzed by measuring the values for each marker, usually in triplicate or in multiple triplicates.

A test dataset is considered to be different than the normal control if at least one, usually at least five, at least ten, at least 15, 20, 25 or more of the parameter values of the profile exceeds the limits that correspond to a predefined level of significance.

To provide significance ordering, the false discovery rate (FDR) may be determined. First, a set of null distributions of dissimilarity values is generated. In one embodiment, the values of observed profiles are permuted to create a sequence of distributions of correlation coefficients obtained out of chance, thereby creating an appropriate set of null distributions of correlation coefficients (see Tusher et al. (2001) PNAS 98, 5116-21, herein incorporated by reference). The set of null distribution is obtained by: permuting the values of each profile for all available profiles; calculating the pair-wise correlation coefficients for all profile; calculating the probability density function of the correlation coefficients for this permutation; and repeating the procedure for N times, where N is a large number, usually 300. Using the N distributions, one calculates an appropriate measure (mean, median, etc.) of the count of correlation coefficient values that their values exceed the value (of similarity) that is obtained from the distribution of experimentally observed similarity values at given significance level.

The FDR is the ratio of the number of the expected falsely significant correlations (estimated from the correlations greater than this selected Pearson correlation in the set of randomized data) to the number of correlations greater than this selected Pearson correlation in the empirical data (significant correlations). This cut-off correlation value may be applied to the correlations between experimental profiles.

Using the aforementioned distribution, a level of confidence is chosen for significance. This is used to determine the lowest value of the correlation coefficient that exceeds the result that would have obtained by chance. Using this method, one obtains thresholds for positive correlation, negative correlation or both. Using this threshold(s), the user can filter the observed values of the pairwise correlation coefficients and eliminate those that do not exceed the threshold(s). Furthermore, an estimate of the false positive rate can be obtained for a given threshold. For each of the individual “random correlation” distributions, one can find how many observations fall outside the threshold range. This procedure provides a sequence of counts. The mean and the standard deviation of the sequence provide the average number of potential false positives and its standard deviation.

The data may be subjected to non-supervised hierarchical clustering to reveal relationships among profiles. For example, hierarchical clustering may be performed, where the Pearson correlation is employed as the clustering metric. One approach is to consider a patient age dataset as a “learning sample” in a problem of “supervised learning”. CART is a standard in applications to medicine (Singer (1999) Recursive Partitioning in the Health Sciences, Springer), which may be modified by transforming any qualitative features to quantitative features; sorting them by attained significance levels, evaluated by sample reuse methods for Hotelling's T2 statistic; and suitable application of the lasso method. Problems in prediction are turned into problems in regression without losing sight of prediction, indeed by making suitable use of the Gini criterion for classification in evaluating the quality of regressions.

This approach has led to what is termed FlexTree (Huang (2004) PNAS 101:10529-10534). FlexTree has performed very well in simulations and when applied to SNP and other forms of data. Software automating FlexTree has been developed. Alternatively LARTree or LART may be used Fortunately, recent efforts have led to the development of such an approach, termed LARTree (or simply LART) Turnbull (2005) Classification Trees with Subset Analysis Selection by the Lasso, Stanford University. The name reflects binary trees, as in CART and FlexTree; the lasso, as has been noted; and the implementation of the lasso through what is termed LARS by Efron et al. (2004) Annals of Statistics 32:407-451. See, also, Huang et al. (2004) Tree-structured supervised learning and the genetics of hypertension. Proc Natl Acad Sci U S A. 101(29):10529-34.

Other methods of analysis that may be used include logic regression. One method of logic regression Ruczinski (2003) Journal of Computational and Graphical Statistics 12:475-512. Logic regression resembles CART in that its classifier can be displayed as a binary tree. It is different in that each node has Boolean statements about features that are more general than the simple “and” statements produced by CART.

Another approach is that of nearest shrunken centroids (Tibshirani (2002) PNAS 99:6567-72). The technology is k-means-like, but has the advantage that by shrinking cluster centers, one automatically selects features (as in the lasso) so as to focus attention on small numbers of those that are informative. The approach is available as PAM software and is widely used. Two further sets of algorithms are random forests (Breiman (2001) Machine Learning 45:5-32 and MART (Hastie (2001) The Elements of Statistical Learning, Springer). These two methods are already “committee methods.” Thus, they involve predictors that “vote” on outcome.

These statistical tools are applicable to all manner of genetic or proteomic data. A set of biomarker, clinical and/or genetic data that can be easily determined, and that is highly informative regarding assessment of physiological age of individuals or tissues, organs, cells, etc., thereof are provided.

Also provided are databases of expression profiles of age signature. Such databases will typically comprise expression profiles of individuals of specific ages, negative expression profiles, etc., where such profiles are as described above.

The analysis and database storage may be implemented in hardware or software, or a combination of both. In one embodiment of the invention, a machine-readable storage medium is provided, the medium comprising a data storage material encoded with machine readable data which, when using a machine programmed with instructions for using said data, is capable of displaying any of the datasets and data comparisons of this invention. Such data may be used for a variety of purposes, such as patient monitoring, initial diagnosis, and the like. Preferably, the invention is implemented in computer programs executing on programmable computers, comprising a processor, a data storage system (including volatile and non-volatile memory and/or storage elements), at least one input device, and at least one output device. Program code is applied to input data to perform the functions described above and generate output information. The output information is applied to one or more output devices, in known fashion. The computer may be, for example, a personal computer, microcomputer, or workstation of conventional design.

Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage media or device (e.g., ROM or magnetic diskette) readable by a general or special purpose programmable computer, for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

A variety of structural formats for the input and output means can be used to input and output the information in the computer-based systems of the present invention. One format for an output means test datasets possessing varying degrees of similarity to a trusted profile. Such presentation provides a skilled artisan with a ranking of similarities and identifies the degree of similarity contained in the test pattern.

The expression profiles and databases thereof may be provided in a variety of media to facilitate their use. “Media” refers to a manufacture that contains the expression profile information of the present invention. The databases of the present invention can be recorded on computer readable media, e.g. any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; and hybrids of these categories such as magnetic/optical storage media. One of skill in the art can readily appreciate how any of the presently known computer readable mediums can be used to create a manufacture comprising a recording of the present database information. “Recorded” refers to a process for storing information on computer readable medium, using any such methods as known in the art. Any convenient data storage structure may be chosen, based on the means used to access the stored information. A variety of data processor programs and formats can be used for storage, e.g. word processing text file, database format, etc.

Nucleic Acids. The nucleic acid sequences of genes associated with aging find various uses, including the preparation of arrays and other probes for hybridization, for the recombinant production of encoded polypeptides, and the like. The nucleic acids include those having a high degree of sequence similarity or sequence identity to the human genes set forth in Table S1. Sequence identity can be determined by hybridization under stringent conditions, for example, at 50° C. or higher and 0.1XSSC (9 mM NaCl/0.9 mM Na citrate). Hybridization methods and conditions are well known in the art, see, e.g., U.S. Pat. No. 5,707,829. Nucleic acids that are substantially identical to the provided nucleic acid sequence, e.g. allelic variants, genetically altered versions of the gene, etc., bind to one of the sequences under stringent hybridization conditions.

Probes specific to the nucleic acid of the invention can be generated using publicly available nucleic acid sequences. The probes are preferably at least about 18 nt, 25 nt, 50 nt or more of the corresponding contiguous sequence of one of the sequences provided in Table S1, and are usually less than about 2, 1, or 0.5 kb in length. Preferably, probes are designed based on a contiguous sequence that remains unmasked following application of a masking program for masking low complexity, e.g. BLASTX. Double or single stranded fragments can be obtained from the DNA sequence by chemically synthesizing oligonucleotides in accordance with conventional methods, by restriction enzyme digestion, by PCR amplification, etc. The probes can be labeled, for example, with a radioactive, biotinylated, or fluorescent tag.

The nucleic acids of the invention can be provided as a linear molecule or within a circular molecule, and can be provided within autonomously replicating molecules (vectors) or within molecules without replication sequences. Expression of the nucleic acids can be regulated by their own or by other regulatory sequences known in the art. The nucleic acids of the invention can be introduced into suitable host cells using a variety of techniques available in the art, such as transferrin polycation-mediated DNA transfer, transfection with naked or encapsulated nucleic acids, liposome-mediated DNA transfer, intracellular transportation of DNA-coated latex beads, protoplast fusion, viral infection, electroporation, gene gun, calcium phosphate-mediated transfection, and the like.

For use in amplification reactions, such as PCR, a pair of primers will be used. The exact composition of the primer sequences is not critical to the invention, but for most applications the primers will hybridize to the subject sequence under stringent conditions, as known in the art. It is preferable to choose a pair of primers that will generate an amplification product of at least about 50 nt, preferably at least about 100 nt. Algorithms for the selection of primer sequences are generally known, and are available in commercial software packages. Amplification primers hybridize to complementary strands of DNA, and will prime towards each other. For hybridization probes, it may be desirable to use nucleic acid analogs, in order to improve the stability and binding affinity. The term “nucleic acid” shall be understood to encompass such analogs.

Polypeptides. Polypeptides encoded by the age-associated genes may find uses. Such polypeptides include native forms, derivative, and fragments thereof. Peptides of interest include fragments of at least about 12 contiguous amino acids, more usually at least about 20 contiguous amino acids, and may comprise 30 or more amino acids, up to the provided peptide, and may extend further to comprise other sequences present in, e.g. precursor polypeptides.

The sequence of the polypeptides may be altered in various ways known in the art to generate targeted changes in sequence, e.g. differing by at least one amino acid, and may differ by at least two but not more than about ten amino acids. The sequence changes may be substitutions, insertions or deletions.

Modifications of interest that do not alter primary sequence include chemical derivatization of polypeptides, e.g., acetylation, or carboxylation. Also included are modifications of glycosylation, e.g. those made by modifying the glycosylation patterns of a polypeptide during its synthesis and processing or in further processing steps; e.g. by exposing the polypeptide to enzymes which affect glycosylation, such as mammalian glycosylating or deglycosylating enzymes. Also embraced are sequences that have phosphorylated amino acid residues, e.g. phosphotyrosine, phosphoserine, or phosphothreonine.

Also included in the subject invention are polypeptides that have been modified using ordinary molecular biological techniques and synthetic chemistry so as to improve their resistance to proteolytic degradation or to optimize solubility properties or to render them more suitable as a therapeutic agent. For examples, the backbone of the peptide may be cyclized to enhance stability (see Friedler et al. (2000) J. Biol. Chem. 275:23783-23789). Analogs of such polypeptides include those containing residues other than naturally occurring L-amino acids, e.g. D-amino acids or non-naturally occurring synthetic amino acids.

The subject peptides may be prepared by in vitro synthesis, using conventional methods as known in the art. Various commercial synthetic apparatuses are available, for example, automated synthesizers by Applied Biosystems, Inc., Foster City, CA, Beckman, etc. By using synthesizers, naturally occurring amino acids may be substituted with unnatural amino acids. The particular sequence and the manner of preparation will be determined by convenience, economics, purity required, and the like.

Antibodies. Antibodies specific for the polypeptides of age-associated genes find uses in some embodiments. As used herein, the term “antibodies” includes antibodies of any isotype, fragments of antibodies which retain specific binding to antigen, including, but not limited to, Fab, Fv, scFv, and Fd fragments, chimeric antibodies, humanized antibodies, single-chain antibodies, and fusion proteins comprising an antigen-binding portion of an antibody and a non-antibody protein. The antibodies may be detectably labeled, e.g., with a radioisotope, an enzyme that generates a detectable product, a green fluorescent protein, and the like. The antibodies may be further conjugated to other moieties, such as members of specific binding pairs, e.g., biotin (member of biotin-avidin specific binding pair), and the like. The antibodies may also be bound to a solid support, including, but not limited to, polystyrene plates or beads, and the like.

Antibodies are prepared in accordance with conventional ways, where the expressed polypeptide or protein is used as an immunogen, by itself or conjugated to known immunogenic carriers, e.g. KLH, pre-S HBsAg, other viral or eukaryotic proteins, or the like. Various adjuvants may be employed, with a series of injections, as appropriate. For monoclonal antibodies, after one or more booster injections, the spleen is isolated, the lymphocytes immortalized by cell fusion, and then screened for high affinity antibody binding. The immortalized cells, i.e. hybridomas, producing the desired antibodies may then be expanded. For further description, see Monoclonal Antibodies: A Laboratory Manual, Harlow and Lane eds., Cold Spring Harbor Laboratories, Cold Spring Harbor, N.Y., 1988. If desired, the mRNA encoding the heavy and light chains may be isolated and mutagenized by cloning in E. coli, and the heavy and light chains mixed to further enhance the affinity of the antibody. Alternatives to in vivo immunization as a method of raising antibodies include binding to phage display libraries, usually in conjunction with in vitro affinity maturation.

Screening Methods. The sample may be prepared in a number of different ways, as is known in the art, e.g., by mRNA isolation from a cell, where the isolated mRNA is used as is, amplified, employed to prepare cDNA, cRNA, etc., as is known in the differential expression art. The sample is typically prepared from a cell or tissue harvested from a subject to be diagnosed, e.g., via blood drawing, biopsy of tissue, using standard protocols, where cell types or tissues from which such nucleic acids may be generated include any tissue in which the expression pattern of the to be determined phenotype exists. Cells may be cultured prior to analysis.

The expression profile may be generated from the initial nucleic acid sample using any convenient protocol. While a variety of different manners of generating expression profiles are known, such as those employed in the field of differential gene expression analysis, one representative and convenient type of protocol for generating expression profiles is array based gene expression profile generation protocols. Such applications are hybridization assays in which a nucleic acid that displays “probe” nucleic acids for each of the genes to be assayed/profiled in the profile to be generated is employed. In these assays, a sample of target nucleic acids is first prepared from the initial nucleic acid sample being assayed, where preparation may include labeling of the target nucleic acids with a label, e.g., a member of signal producing system. Following target nucleic acid sample preparation, the sample is contacted with the array under hybridization conditions, whereby complexes are formed between target nucleic acids that are complementary to probe sequences attached to the array surface. The presence of hybridized complexes is then detected, either qualitatively or quantitatively.

Specific hybridization technology which may be practiced to generate the expression profiles employed in the subject methods includes the technology described in U.S. Pat. Nos.: 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992; the disclosures of which are herein incorporated by reference; as well as WO 95/21265; WO 96/31622; WO 97/10365; WO 97/27317; EP 373 203; and EP 785 280. In these methods, an array of “probe” nucleic acids that includes a probe for each of the phenotype determinative genes whose expression is being assayed is contacted with target nucleic acids as described above. Contact is carried out under hybridization conditions, e.g., stringent hybridization conditions as described above, and unbound nucleic acid is then removed. The resultant pattern of hybridized nucleic acid provides information regarding expression for each of the genes that have been probed, where the expression information is in terms of whether or not the gene is expressed and, typically, at what level, where the expression data, i.e., expression profile, may be both qualitative and quantitative.

Alternatively, non-array based methods for quantitating the levels of one or more nucleic acids in a sample may be employed, including quantitative PCR, and the like.

Where the expression profile is a protein expression profile, any convenient protein quantitation protocol may be employed, where the levels of one or more proteins in the assayed sample are determined. Representative methods include, but are not limited to; proteomic arrays, flow cytometry, standard immunoassays, etc.

Reagents and Kits. Also provided are reagents and kits thereof for practicing one or more of the above-described methods. The subject reagents and kits thereof may vary greatly. Reagents of interest include reagents specifically designed for use in production of the above described expression profiles of phenotype determinative genes.

One type of such reagent is-an array of probe nucleic acids in which the phenotype determinative genes of interest are represented. A variety of different array formats are known in the art, with a wide variety of different probe structures, substrate compositions and attachment technologies. Representative array structures of interest include those described in U.S. Pat. Nos.: 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992; the disclosures of which are herein incorporated by reference; as well as WO 95/21265; WO 96/31622; WO 97/10365; WO 97/27317; EP 373 203; and EP 785 280. In certain embodiments, the number of genes that are represented on the array are at least 10, usually at least 25, and may be at least 50, 100, up to including all of the genes listed, preferably utilizing the top ranked set of genes. The subject arrays may include only those genes that are listed, or they may include additional genes that are not listed. Where the subject arrays include probes for such additional genes, in certain embodiments the number % of additional genes that are represented does not exceed about 50%, usually does not exceed about 25%. In many embodiments where additional genes are included, a great majority of genes in the collection are age associated genes, where by great majority is meant at least about 75%, usually at least about 80% and sometimes at least about 85, 90, 95% or higher, including embodiments where 100% of the genes in the collection are age associated genes.

Another type of reagent that is specifically tailored for generating expression profiles of age associated genes is a collection of gene specific primers that is designed to selectively amplify such genes, for use in quantitative PCR and other quantitation methods. Gene specific primers and methods for using the same are described in U.S. Pat. No. 5,994,076, the disclosure of which is herein incorporated by reference. Of particular interest are collections of gene specific primers that have primers for at least 10 of the genes listed, often a plurality of these genes, e.g., at least 25, and may be 50, 100 or more to include all of the genes listed for a signature of interest. The subject gene specific primer collections may include only those genes that are listed, or they may include primers for additional genes that are not listed. Where the subject arrays include probes for such additional genes, in certain embodiments the number % of additional genes that are represented does not exceed about 50%, usually does not exceed about 25%. In many embodiments where additional genes are included, a great majority of genes in the collection are age associated genes, where by great majority is meant at least about 75%, usually at least about 80% and sometimes at least about 85, 90, 95% or higher, including embodiments where 100% of the genes in the collection are age associated genes.

The kits of the subject invention may include the above described arrays and/or gene specific primer collections. The kits may further include a software package for statistical analysis of one or more phenotypes, and may include a reference database for calculating the probability of susceptibility. The kit may include reagents employed in the various methods, such as primers for generating target nucleic acids, dNTPs and/or rNTPs, which may be either premixed or separate, one or more uniquely labeled dNTPs and/or rNTPs, such as biotinylated or Cy3 or Cy5 tagged dNTPs, gold or silver particles with different scattering spectra, or other post synthesis labeling reagent, such as chemically active derivatives of fluorescent dyes, enzymes, such as reverse transcriptases, DNA polymerases, RNA polymerases, and the like, various buffer mediums, e.g. hybridization and washing buffers, prefabricated probe arrays, labeled probe purification reagents and components, like spin columns, etc., signal generation and detection reagents, e.g. streptavidin-alkaline phosphatase conjugate, chemifluorescent or chemiluminescent substrate, and the like.

In addition to the above components, the subject kits will further include instructions for practicing the subject methods. These instructions may be present in the subject kits in a variety of forms, one or more of which may be present in the kit. One form in which these instructions may be present is as printed information on a suitable medium or substrate, e.g., a piece or pieces of paper on which the information is printed, in the packaging of the kit, in a package insert, etc. Yet another means would be a computer readable medium, e.g., diskette, CD, etc., on which the information has been recorded. Yet another means that may be present is a website address which may be used via the internet to access the information at a removed site. Any convenient means may be present in the kits.

Compound Screening and Analysis of Therapy. The methods of the invention find use in screening tissues, cells, organs, etc. for a determination of physiological age. In such assays, an age signature is determined for the sample of interest, and used to assess the physiological age. The methods of the invention also find use in screening assays for agents that modulate aging. Such methods usually involve contacting cells, e.g. aged cells, with a candidate agent, and determining the change in expression of the markers provided herein in response to said treatment. In some embodiments, the cells are kidney cells, e.g. tubule cells, kidney organ cultures, glomeruli, cortex, and the like.

In some embodiments, the cells are provided in an in vitro culture environment, for example as a tissue section, primary cell culture, cell line, combination of cells, and the like. In other embodiments, the cells are provided in an in vivo environment, for example an animal model for age in pre-clinical trials, or human subjects in clinical trials and to follow the efficacy of therapeutic regimens. A review of animal models for age may be found at Narayanaswamy et al. (2000) Journal of Vascular and Interventional Radiology 11:5-17, herein incorporated by reference with respect to the use of various animal models.

Following exposure to the candidate compound, the panel of biomarkers is assessed for expression levels, for example in the absence or presence of the agent; in a time course following administration; in combination with other biologically active agents; in combination with non-pharmacologic therapy; and the like.

The compounds are typically added in solution, or readily soluble form, to the culture or animal. A plurality of assays may be run in parallel with different compound concentrations to obtain a differential response to the various concentrations. As known in the art, determining the effective concentration of a compound typically uses a range of concentrations resulting from 1:10, or other log scale, dilutions. The concentrations may be further refined with a second series of dilutions, if necessary. Typically, one of these concentrations serves as a negative control, i.e. at zero concentration or below the level of detection.

Compounds of interest encompass numerous chemical classes, though typically they are organic molecules. Candidate agents comprise functional groups necessary for structural interaction with proteins, particularly hydrogen bonding, and typically include at least an amine, carbonyl, hydroxyl or carboxyl group, preferably at least two of the functional chemical groups. The candidate agents often comprise cyclical carbon or heterocyclic structures and/or aromatic or polyaromatic structures substituted with one or more of the above functional groups. Candidate agents are also found among biomolecules including peptides, saccharides, fatty acids, steroids, purines, pyrimidines, derivatives, structural analogs or combinations thereof.

Included are pharmacologically active drugs, genetically active molecules, etc. Compounds of interest include chemotherapeutic agents, anti-inflammatory agents, hormones or hormone antagonists, etc.

Compounds and candidate agents are obtained from a wide variety of sources including libraries of synthetic or natural compounds. For example, numerous means are available for random and directed synthesis of a wide variety of organic compounds and biomolecules, including expression of randomized oligonucleotides and oligopeptides. Alternatively, libraries of natural compounds in the form of bacterial, fungal, plant and animal extracts are available or readily produced. Additionally, natural or synthetically produced libraries and compounds are readily modified through conventional chemical, physical and biochemical means, and may be used to produce combinatorial libraries. Known pharmacological agents may be subjected to directed or random chemical modifications, such as acylation, alkylation, esterification, amidification, etc. to produce structural analogs.

Agents that modulate activity of age associated proteins provide a point of therapeutic or prophylactic intervention. Numerous agents are useful in modulating this activity, including agents that directly modulate expression, e.g. expression vectors, antisense specific for the targeted gene; and agents that act on the protein, e.g. specific antibodies and analogs thereof, small organic molecules that block biological activity, etc.

Antisense molecules can be used to down-regulate expression in cells. The antisense reagent may be antisense oligonucleotides (ODN), particularly synthetic ODN having chemical modifications from native nucleic acids, or nucleic acid constructs that express such antisense molecules as RNA. The antisense sequence is complementary to the mRNA of the targeted gene, and inhibits expression of the targeted gene products. Antisense molecules inhibit gene expression through various mechanisms, e.g. by reducing the amount of mRNA available for translation, through activation of RNAse H, or steric hindrance. One or a combination of antisense molecules may be administered, where a combination may comprise multiple different sequences.

Antisense molecules may be produced by expression of all or a part of the target gene sequence in an appropriate vector, where the transcriptional initiation is oriented such that an antisense strand is produced as an RNA molecule. Alternatively, the antisense molecule is a synthetic oligonucleotide. Antisense oligonucleotides will generally be at least about 7, usually at least about 12, more usually at least about 20 nucleotides in length, and not more than about 500, usually not more than about 50, more usually not more than about 35 nucleotides in length, where the length is governed by efficiency of inhibition, specificity, including absence of cross-reactivity, and the like.

Antisense oligonucleotides may be chemically synthesized by methods known in the art (see Wagner et al. (1993) supra. and Milligan et al., supra.) Preferred oligonucleotides are chemically modified from the native phosphodiester structure, in order to increase their intracellular stability and binding affinity. A number of such modifications have been described in the literature, which alter the chemistry of the backbone, sugars or heterocyclic bases.

In one embodiment of the invention, RNAi technology is used. As used herein, RNAi technology refers to a process in which double-stranded RNA is introduced into cells expressing a candidate gene to inhibit expression of the candidate gene, i.e., to “silence” its expression. The dsRNA is selected to have substantial identity with the candidate gene. In general such methods initially involve transcribing a nucleic acids containing all or part of a candidate gene into single- or double-stranded RNA. Sense and anti-sense RNA strands are allowed to anneal under appropriate conditions to form dsRNA. The resulting dsRNA is introduced into cells via various methods. Usually the dsRNA consists of two separate complementary RNA strands. However, in some instances, the dsRNA may be formed by a single strand of RNA that is self-complementary, such that the strand loops back upon itself to form a hairpin loop. Regardless of form, RNA duplex formation can occur inside or outside of a cell.

dsRNA can be prepared according to any of a number of methods that are known in the art, including in vitro and in vivo methods, as well as by synthetic chemistry approaches. Examples of such methods include, but are not limited to, the methods described by Sadher et al. (Biochem. Int. 14:1015, 1987); by Bhattacharyya (Nature 343:484, 1990); and by Livache, et al. (U.S. Pat. No. 5,795,715), each of which is incorporated herein by reference in its entirety. Single-stranded RNA can also be produced using a combination of enzymatic and organic synthesis or by total organic synthesis. The use of synthetic chemical methods enables one to introduce desired modified nucleotides or nucleotide analogs into the dsRNA. dsRNA can also be prepared in vivo according to a number of established methods (see, e.g., Sambrook, et al. (1989) Molecular Cloning: A Laboratory Manual, 2nd ed.; Transcription and Translation (B. D. Hames, and S. J. Higgins, Eds., 1984); DNA Cloning, volumes I and II (D. N. Glover, Ed., 1985); and Oligonucleotide Synthesis (M. J. Gait, Ed., 1984, each of which is incorporated herein by reference in its entirety).

A number of options can be utilized to deliver the dsRNA into a cell or population of cells. For instance, RNA can be directly introduced intracellularly. Various physical methods are generally utilized in such instances, such as administration by microinjection (see, e.g., Zernicka-Goetz, et al. (1997) Development 124:1133-1137; and Wianny, et al. (1998) Chromosoma 107: 430-439). Other options for cellular delivery include permeabilizing the cell membrane and electroporation in the presence of the dsRNA, liposome-mediated transfection, or transfection using chemicals such as calcium phosphate. A number of established gene therapy techniques can also be utilized to introduce the dsRNA into a cell. By introducing a viral construct within a viral particle, for instance, one can achieve efficient introduction of an expression construct into the cell and transcription of the RNA encoded by the construct.

### Experimental

The following examples are put forth so as to provide those of ordinary skill in the art with a complete disclosure and description of how to make and use the present invention, and are not intended to limit the scope of what the inventors regard as their invention nor are they intended to represent that the experiments below are all or the only experiments performed. Efforts have been made to ensure accuracy with respect to numbers used (e.g., amounts, temperature, etc.) but some experimental errors and deviations should be accounted for. Unless indicated otherwise, parts are parts by weight, molecular weight is weight average molecular weight, temperature is in degrees Centigrade, and pressure is at or near atmospheric.

All publications and patent applications cited in this specification are herein incorporated by reference as if each individual publication or patent application were specifically and individually indicated to be incorporated by reference.

The present invention has been described in terms of particular embodiments found or proposed by the present inventor to comprise preferred modes for the practice of the invention. It will be appreciated by those of skill in the art that, in light of the present disclosure, numerous modifications and changes can be made in the particular embodiments exemplified without departing from the intended scope of the invention. For example, due to codon redundancy, changes can be made in the underlying DNA sequence without affecting the protein sequence. Moreover, due to biological functional equivalency considerations, changes can be made in protein structure without affecting the biological action in kind or amount. All such modifications are intended to be included within the scope of the appended claims.

### Example 1

### Genomic Convergence Reveals Common Variants Associated with Gene Expression and Aging in the Human Kidney

Results

Selection of Age-Regulated Genes

We chose to identify genes that associate with a focused phenotype of aging rather than the nonspecific phenotype of living to age 100. In this study, we extended the genomic convergence approach to find genes associated with kidney aging. We determined which genes change expression with age in the kidney because these are likely enriched for genes that affect physiological aging. For example, a gene that decreases expression with age may contribute to poor renal function because it is expressed at levels below a physiological threshold in the elderly.

We obtained a set of 447 age-regulated genes from a genome-wide transcriptional profile of aging in the human kidney (Rodwell G E, Sonu R, Zahn J M, Lund J, Wilhelmy J, et al (2004) A Transcriptional Profile of Aging in the Human Kidney, PLoS Biol 2:e427). In addition, previous work had identified four genetic pathways that showed common age-regulation in diverse tissues (kidney, muscle and brain). These pathways include 152 extracellular matrix genes, 85 ribosomal genes, 35 chloride transport genes, and 95 electron transport chain genes (Zahn J M, Sonu R, Vogel H, Crane E, Mazan-Mamczarz K, et al. (2006) Transcriptional Profiling of Aging in Human Muscle Reveals a Common Aging Signature, PLoS Genet 2:e115). We combined the age-regulated genes with the age-regulated pathways and obtained a set of 630 genes that change expression with age.

For 103 of the 630 age-regulated kidney genes, we found single nucleotide polymorphisms that associate with expression level (eSNPs). We tested the eSNPs for association with kidney aging, as measured by glomerular filtration rate (GFR), using data from the Baltimore Longitudinal Study of Aging (BLSA) and the InCHIANTI study. We found a SNP association (rs1711437 in MMP20) with kidney aging (uncorrected p=3.6×10−5, empirical p=0.01) that explains 1-2% of the variance in GFR among individuals. This study provides the first evidence for a gene association with kidney aging in humans.

In addition to selecting genes that change expression with age in the kidney, we also identified alleles that associate with the expression of the gene. If a gene is functionally involved in kidney aging and if DNA differences in the gene cause variation in expression among individuals, then there is an association between the specific allele carried by an individual and that individual's physiological aging trajectory.

Finally, we tested the set of candidate genes from the expression studies for association with kidney aging in two studies of normal aging, the Baltimore Longitudinal Study of Aging and the InCHIANTI study. Using this genomic convergence approach, we were able to find SNPs in the matrix metallopeptidase gene MMP20 (GeneID 9313) that are significantly associated with kidney aging. One gene that encodes an extracellular matrix protein, MMP20, is significantly associated with kidney aging, providing the first gene association with kidney aging.

Identification of Expression SNPs by Total Expression Analysis

If age-regulated genes are important for kidney function, then variation in gene expression may correlate with kidney function. We focused on finding expression-associated SNPs (eSNPs) using two methods. The first method searched for association between SNPs in a gene and expression level of that gene. We selected 1041 SNPs in the promoter regions and 386 SNPs in the coding and untranslated regions of the 630 age-regulated genes. We then used a custom Illumina® GoldenGate® assay to genotype these SNPs in 95 kidney samples. The characteristics of the kidney aging study samples are shown in Table 1 below:

TABLE 1
SNPs that associate with the kidney aging phenotype of glomerular
filtration rate.

| SNP | Gene | p-value |
|---|---|---|
| rs1711437 | MMP20 | 1.5E−05 |
| rs706308 | SETD7 | 3.2E−05 |
| rs6549923 | RBMS3 | 5.4E−05 |
| rs1784418 | MMP20 | 5.7E−05 |
| rs2697852 | SPON1 | 8.2E−05 |
| [symbol] 9385512 | ARHGAP10 | 8.8E−05 |

[symbol]

indicates data missing or illegible when filed

Total expression data was obtained from whole-genome microarrays of 69 kidneys from Rodwell et al. (2004), and new expression data from 26 kidney samples. Kidney samples were obtained from normal tissue of patients aged 29 to 92 years. The kidney samples were dissected into cortex (94 samples) and medulla (59 samples). Expression levels of each gene in the genome were determined using Affymetrix® HG-U133A and HG-U133B microarrays.

We compared the genotypes from our chosen SNPs to their corresponding gene expression levels and found 16 SNPs in 12 genes associated with total expression level (Linear Regression, p<0.001). Four of the genes have two significant SNPs; in two cases, the SNPs are in different linkage disequilibrium blocks indicating that the eSNPs are independent, and in two cases, the SNPs are linked to each other (r²>0.8 HapMap CEU population) and thus represent only one significant association.

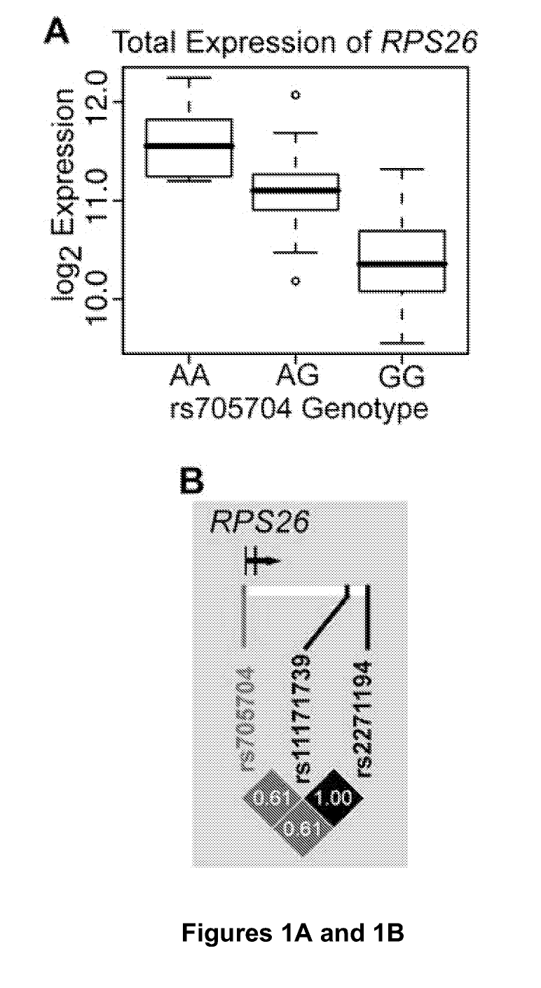

One promoter region SNP that showed strong association with total expression was rs705704, which is 274 by upstream of the transcription start site of ribosomal protein S26 (RPS26, p=1.2×10⁻²⁰, FIG. 1A). Individuals with the AA genotype have the highest expression, heterozygotes have medium expression, and GG homozygotes have the lowest expression of RPS26 (GeneID 6231). SNPs partially linked to rs705704 have previously been found to associate with total expression level of RPS26 in two other studies (Cheung V G, Spielman R S, Ewens KG, Weber T M, Morley M, et al. (2005)Mapping Determinants of Human Gene Expression by Regional and Genome-wide Association, Nature 437:1365-1369, and Myers A J, Gibbs J R, Webster J A, Rohrer K, Zhao A, et al. (2007) A Survey of Genetic Human Cortical Gene Expression, Nat Genet 39: 1494-1499). These findings are shown in FIG. 1B.

Identification of Expression SNPs by Allele-Specific Expression Analysis

The second method identified differential allelic expression within heterozygotes. In this method, the expression levels of each allele are measured directly by assaying SNPs within the mRNA transcript. Heterozygotes were examined for allelic transcript levels that differ from each other, using genomic DNA allelic ratios as a control of 1:1 hybridization intensity. Because differential expression is examined within heterozygotes, mRNA levels are measured within the same genetic background and cellular environment.

Allele-specific expression was used to test all of the age-regulated genes that had SNPs in their mRNAs. We assayed the relative expression levels of 386 mRNA SNPs in 276 age-regulated genes in 96 individuals. Most of the mRNA SNPs were in the 3′ untranslated regions of genes (249), some were in coding regions (115), and a few were in the 5′ untranslated regions.

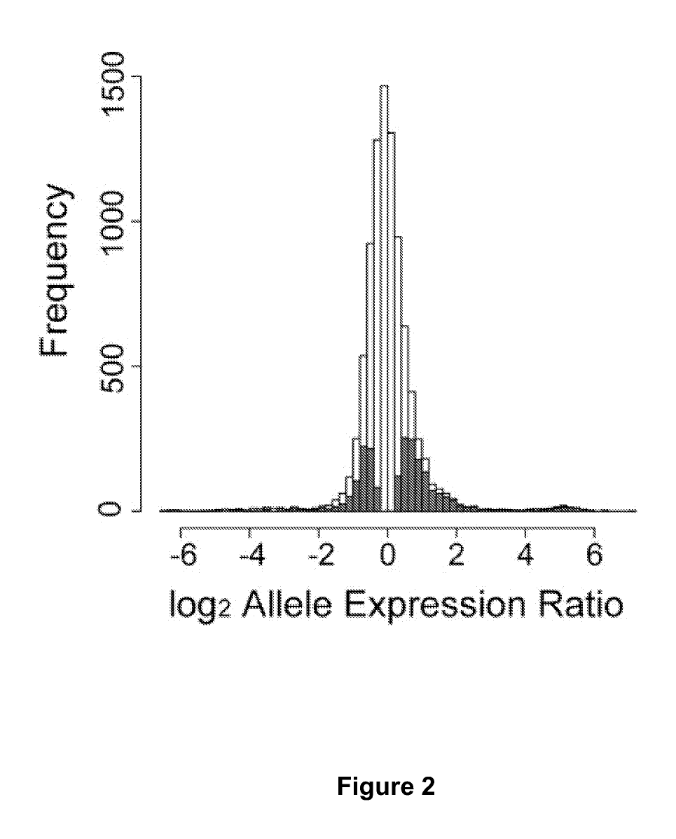

Oligonucleotides specific for each allele of each SNP were designed for use in the Illumina® GoldenGate® multiplex PCR assay. Kidney cortex mRNA was reverse transcribed into cDNA prior to the start of the GoldenGate® assay. In the assay, the PCR products for each allele were labeled with a different fluorophore and the intensities of each allele were compared to determine if one allele had a higher expression than the other. The cDNA allelic intensities for each SNP were compared within heterozygotes to test for allelic imbalance. Because the intensities from each fluorophore (Cy3 and Cy5) can differ, the genomic DNA allelic intensities of heterozygotes were used as a control to define a 1:1 allelic ratio for each SNP. The cDNA allelic ratio for each heterozygote was compared to the 95% confidence interval surrounding the mean DNA allele intensity ratio for each SNP. At least five heterozygotes were tested per SNP. If the cDNA allele intensity ratio for more than 50% of individual heterozygotes fell outside the 95% confidence interval and the combined p-value was less than 10⁻⁶, the SNP was considered to be an eSNP. In total, 107 eSNPs in 95 age-regulated genes were detected (Table 2, FIG. 2). The median fold-change of the higher expressed allele to the lower-expressed allele was 2.1. The level of overexpression of one allele varied widely among genes, from 1.4-fold to apparent monoallelic (>10-fold) expression (FIG. 2). Two genes (SPP1, GeneID 6696 and TIMP3, GeneID 7078) had linked eSNPs (r²>0.8 HapMap CEU population) that both showed allele-specific differences in expression. Ten genes contained two eSNPs that independently showed differences in expression.

TABLE 2

| | | Number | ASE | Major allele (# | Minor allele (# | Mean fold change (higher | Fisher's Meta P- |
|---|---|---|---|---|---|---|---|
| Gene | SNP | heterozygotes | proportion | higher expression) | higher expression) | allele/lower allele) | value |
| PEG3 | rs1055359 | 32 | 1 | A (12) | G (20) | 11.7 | <1E−100 |
| COL17A1 | rs805701 | 23 | 1 | A (23) | G (0) | 2.2 | <1E−100 |
| LAMC1 | rs2296292 | 13 | 1 | A (12) | C (1) | 2.2 | 1E−44 |
| MMP8 | rs1276282 | 12 | 1 | C (0) | T (12) | 2.6 | <1E−100 |
| CLCA1 | rs1882753 | 10 | 1 | T (10) | C (0) | 2.4 | <1E−100 |
| PAPPA2 | rs2294654 | 9 | 1 | G (0) | A (9) | 3.2 | <1E−100 |
| GABRG2 | rs211037 | 8 | 1 | C (1) | T (7) | 2.1 | <1E−100 |
| SLC16A7 | rs10506399 | 36 | 0.97 | G (0) | A (35) | 2 | <1E−100 |
| PDIA4 | rs1052549 | 31 | 0.97 | T (0) | G (30) | 1.7 | 1E−55 |
| ATHL1 | rs2242565 | 37 | 0.95 | A (34) | G (1) | 3.1 | <1E−100 |
| FAM83F | rs17406386 | 33 | 0.94 | A (31) | G (0) | 4.1 | <1E−100 |
| BRP44L | rs3728 | 43 | 0.93 | T (0) | G (40) | 1.6 | <1E−100 |
| LAMA3 | rs1154226 | 29 | 0.93 | C (0) | G (27) | 2 | <1E−100 |
| KERA | rs1990548 | 27 | 0.93 | A (24) | C (1) | 1.9 | <1E−100 |
| TXNDC5 | rs8643 | 15 | 0.93 | G (14) | A (0) | 3.1 | 1E−40 |
| FLJ38725 | rs7992315 | 14 | 0.93 | T (13) | C (0) | 1.6 | 1E−46 |
| COX7A2L | rs1997 | 52 | 0.92 | A (0) | T (48) | 1.6 | 1E−91 |
| MMP20 | rs2245803 | 12 | 0.92 | C (0) | A (11) | 2.1 | <1E−100 |
| COL17A1 | rs9425 | 12 | 0.92 | G (0) | A (11) | 1.8 | <1E−100 |
| RGS6 | rs3291 | 23 | 0.91 | A (20) | G (1) | 2.6 | <1E−100 |
| CXCL14 | rs1046092 | 11 | 0.91 | A (0) | G (10) | 1.8 | 1E−65 |
| SPP1 | rs4754 | 40 | 0.9 | T (34) | C (2) | 4.8 | <1E−100 |
| PHCA | rs591043 | 31 | 0.9 | A (0) | G (28) | 2.3 | 1E−99 |
| MATN2 | rs3088121 | 21 | 0.9 | A (1) | G (18) | 1.6 | 1E−62 |
| GPC6 | rs1535692 | 20 | 0.9 | G (0) | A (18) | 2.2 | <1E−100 |
| GPC5 | rs553717 | 10 | 0.9 | G (0) | A (9) | 2.1 | <1E−100 |
| GABRA4 | rs7678338 | 45 | 0.89 | T (40) | C (0) | 4.5 | <1E−100 |
| GPR61 | rs17575798 | 9 | 0.89 | G (0) | A (8) | 1.9 | 1E−23 |
| ADRA2A | rs3750625 | 9 | 0.89 | C (0) | A (8) | 1.8 | <1E−100 |
| TPD52 | rs10098470 | 8 | 0.88 | G (7) | A (0) | 1.4 | 1E−43 |
| TIMP3 | rs1065314 | 36 | 0.86 | T (31) | C (0) | 3.1 | <1E−100 |
| DSPP | rs2615489 | 22 | 0.86 | A (19) | G (0) | 2.8 | <1E−100 |
| SPP1 | rs9138 | 40 | 0.85 | A (28) | C (6) | 6.2 | <1E−100 |
| TMEM92 | rs2254177 | 12 | 0.83 | C (0) | T (10) | 1.8 | <1E−100 |
| CHRNA3 | rs660652 | 11 | 0.82 | G (0) | A (9) | 2.8 | <1E−100 |
| OSMR | rs1239344 | 36 | 0.81 | G (0) | A (29) | 1.7 | <1E−100 |
| TIMP3 | rs1427384 | 36 | 0.81 | A (1) | G (28) | 2.9 | <1E−100 |
| GABRP | rs929762 | 15 | 0.8 | T (12) | C (0) | 2.4 | <1E−100 |
| GPNMB | rs5850 | 42 | 0.79 | G (32) | A (1) | 1.8 | 1E−59 |
| C3 | rs2230199 | 28 | 0.79 | C(1) | G (21) | 2.8 | <1E−100 |
| C7 | rs14190 | 37 | 0.78 | A (6) | G (23) | 1.7 | 1E−77 |
| GOT2 | rs6993 | 32 | 0.78 | C (0) | T (25) | 1.5 | <1E−100 |
| RAFTLIN | rs6900 | 13 | 0.77 | C (10) | T (0) | 1.6 | 1E−16 |
| NDUFC2 | rs499799 | 29 | 0.76 | G (21) | C (1) | 4.6 | 1E−54 |
| THBS4 | rs423906 | 20 | 0.75 | G (0) | A (15) | 2.1 | <1E−100 |
| MMP9 | rs13969 | 42 | 0.74 | A (0) | C (31) | 3 | 1E−67 |
| RPL15 | rs1133926 | 27 | 0.74 | A (1) | G (19) | 3.6 | <1E−100 |
| LPL | rs3208305 | 41 | 0.73 | A (9) | T (21) | 2.3 | <1E−100 |
| MMP25 | rs1043298 | 37 | 0.73 | T (1) | A (26) | 1.8 | <1E−100 |
| NDUFAF1 | rs1899 | 33 | 0.73 | G (24) | A (0) | 2 | 1E−50 |
| CLCA1 | rs1321694 | 15 | 0.73 | A (0) | T (11) | 4 | <1E−100 |
| LOC387758 | rs7111860 | 15 | 0.73 | T (11) | G (0) | 3.4 | <1E−100 |
| SOHLH2 | rs2296967 | 11 | 0.73 | G (0) | A (8) | 3 | <1E−100 |
| SPARCL1 | rs9933 | 45 | 0.71 | C (32) | T (0) | 1.6 | 1E−69 |
| PLK2 | rs15915 | 35 | 0.71 | G (1) | A (24) | 1.7 | 1E−67 |
| THBS4 | rs1866389 | 28 | 0.71 | C (19) | G(1) | 1.8 | <1E−100 |
| MMP3 | rs602128 | 24 | 0.71 | T (17) | C (0) | 2.1 | <1E−100 |
| LTF | rs1126478 | 24 | 0.71 | A (3) | G (14) | 4.1 | <1E−100 |
| GPC6 | rs17645969 | 30 | 0.7 | C (2) | A (19) | 1.9 | <1E−100 |
| DCN | rs7441 | 10 | 0.7 | C (0) | T (7) | 1.8 | 1E−39 |
| FMO5 | rs894469 | 10 | 0.7 | A (7) | G (0) | 3.7 | <1E−100 |
| PRICKLE1 | rs1043652 | 35 | 0.69 | G (1) | A (23) | 2.1 | 1E−48 |
| FA2H | rs1046371 | 37 | 0.68 | C(1) | G (24) | 1.4 | 1E−44 |
| MMP9 | rs20544 | 49 | 0.67 | T (32) | C (1) | 3.2 | <1E−100 |
| HAPLN1 | rs2242128 | 18 | 0.67 | G (1) | C (11) | 2.8 | <1E−100 |
| SMPD2 | rs1476387 | 6 | 0.67 | G (3) | T (1) | 6.7 | 1E−95 |
| ATP5C1 | rs4655 | 41 | 0.66 | T (26) | C (1) | 2.1 | <1E−100 |
| RHOBTB3 | rs12351 | 37 | 0.65 | T (24) | G (0) | 3.3 | <1E−100 |
| PHYH | rs11133 | 31 | 0.65 | G (9) | A (11) | 1.7 | 1E−70 |
| IGF1R | rs2229765 | 23 | 0.65 | G (8) | A (7) | 1.4 | 1E−53 |
| POSTN | rs6750 | 20 | 0.65 | G (7) | C(6) | 2.8 | <1E−100 |
| SP2 | rs2229358 | 47 | 0.64 | G (1) | A (29) | 1.6 | <1E−100 |
| MATN1 | rs20566 | 36 | 0.64 | A (22) | G (1) | 1.6 | 1E−51 |
| RARRES1 | rs2307064 | 28 | 0.64 | C (9) | T (9) | 1.5 | <1E−100 |
| RPL28 | rs7255657 | 11 | 0.64 | A (6) | G (1) | 1.9 | 1E−21 |
| PECI | rs3177253 | 30 | 0.63 | G (18) | A (1) | 2.4 | 1E−59 |
| LAMB1 | rs7561 | 42 | 0.62 | C (25) | A (1) | 2.7 | 1E−59 |
| GABRA4 | rs17599102 | 39 | 0.62 | C (1) | T (23) | 2.2 | <1E−100 |
| ATP5F1 | rs1264899 | 38 | 0.61 | G (22) | A (1) | 1.4 | 1E−32 |
| MTR | rs2853522 | 33 | 0.61 | C (14) | A (6) | 1.5 | 1E−44 |
| NOV | rs14324 | 28 | 0.61 | C (1) | T (16) | 1.7 | 1E−58 |
| CLIC6 | rs2834601 | 18 | 0.61 | C (2) | T (9) | 2.2 | 1E−60 |
| KIAA0644 | rs740252 | 40 | 0.6 | G (1) | C (23) | 2 | <1E−100 |
| EGF | rs3733625 | 15 | 0.6 | A (1) | G (8) | 5.1 | <1E−100 |
| MFGE8 | rs8530 | 27 | 0.59 | G (3) | A (13) | 1.6 | <1E−100 |
| FLRT2 | rs17646457 | 22 | 0.59 | G (1) | A (12) | 1.9 | 1E−55 |
| LIX1 | rs316234 | 37 | 0.57 | C (1) | A (20) | 1.9 | <1E−100 |
| IGF1R | rs3743262 | 14 | 0.57 | C (2) | T (6) | 3.4 | 1E−54 |
| GLRB | rs1129304 | 36 | 0.56 | T (19) | A (1) | 1.5 | 1E−77 |
| FN1 | rs2289202 | 20 | 0.55 | G (0) | A (11) | 2 | 1E−42 |
| MAP4 | rs1061003 | 41 | 0.54 | C (22) | G (0) | 1.5 | 1E−32 |
| AATF | rs1045056 | 41 | 0.54 | T (0) | C (22) | 2.8 | 1E−30 |
| ADAMTS5 | rs457947 | 37 | 0.54 | C (19) | G (1) | 1.6 | <1E−100 |
| CFB | rs641153 | 13 | 0.54 | C (3) | T (4) | 1.4 | 1E−38 |
| TGFB2 | rs900 | 13 | 0.54 | A (7) | T (0) | 2.1 | 1E−15 |
| MMP7 | rs10502001 | 32 | 0.53 | C (13) | T (4) | 1.6 | 1E−25 |
| ADCY1 | rs2280495 | 19 | 0.53 | C (1) | T (9) | 1.8 | 1E−37 |
| SLC16A7 | rs3763979 | 17 | 0.53 | G (3) | A (6) | 2.5 | <1E−100 |
| HIBADH | rs1052741 | 29 | 0.52 | C (13) | T (2) | 2.7 | 1E−45 |
| FBLN2 | rs1061375 | 40 | 0.5 | G (1) | A (19) | 2 | 1E−35 |
| FLRT2 | rs10309 | 38 | 0.5 | G (2) | A (17) | 2.1 | <1E−100 |
| C18orf1 | rs3744811 | 32 | 0.5 | C (1) | T (15) | 1.9 | 1E−38 |
| SPARCL1 | rs1049539 | 32 | 0.5 | A (1) | G (15) | 1.7 | 1E−22 |
| PTPRO | rs1050646 | 18 | 0.5 | T (0) | C (9) | 1.4 | 1E−25 |
| COL6A3 | rs4663722 | 18 | 0.5 | C (2) | G (7) | 1.5 | 1E−24 |

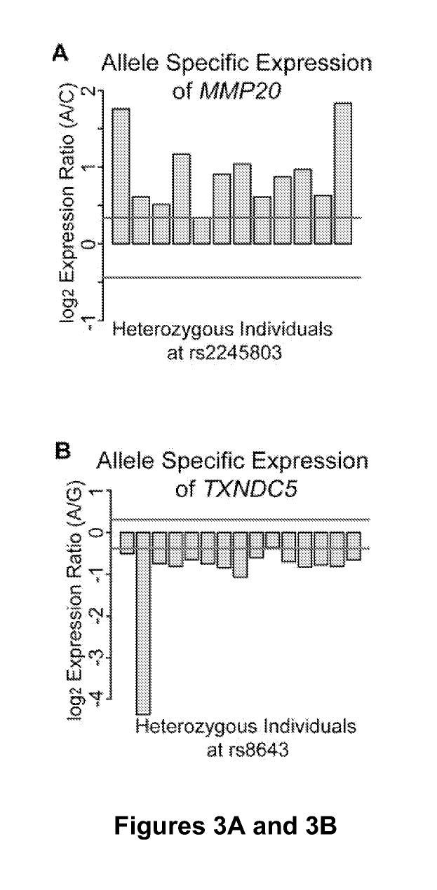

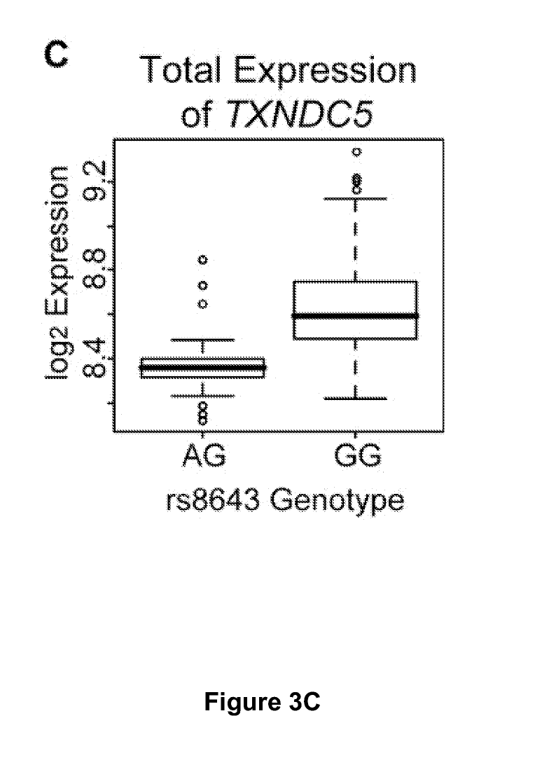

For most of these eSNPs (98/107), the higher-expressed allele was usually the same across heterozygotes. For example, the A allele is expressed at higher levels than the C allele in 11 of 12 heterozygotes tested at rs2245803 in the gene matrix metalloproteinase 20 (MMP20, FIG. 3A), and the G allele is expressed at higher levels than the A allele in 14 of 15 heterozygotes tested at rs8643 in TXNDC5 (GeneID 81567, FIG. 3B). In these SNPs, the functional SNP causing the expression difference is likely linked to the SNP we measured. For a smaller subset of the SNPs (9/107 SNPs), both alleles were observed at a higher level in different heterozygotes. One explanation for this is that the functional SNP causing the expression difference is not closely linked to the SNP we measured in the transcript. Another explanation is that epigenetic effects such as imprinting could cause the differences in expression from the two homologs. For example, one of the genes in which either allele can be associated with higher expression is PEGS (GeneID 5178, paternally expressed 3), which is known to be imprinted. Presumably, the higher-expressed allele in our studies is from the paternal homolog.

386 SNPs were tested for association with expression by both the allele-specific method and the total expression method. While 107 eSNPs were identified by the allele-specific method, only five eSNPs were identified by the total expression method. Of the five SNPs found by the total expression method, four were also found by the allele-specific expression method (shown in bold in Table 2), One example is rs8643 in the gene TXNDC5, in which both methods found that the G allele is associated with higher expression levels than the A allele (FIGS. 3B-3C). These results indicate that the allele-specific assay identified many more eSNPs and is likely more sensitive in detecting expression differences than the total expression assay. A probable reason is that for the allele-specific assay, expression is measured from two alleles in heterozygotes and thus variability due to genetic background and environmental effects are reduced or eliminated.

Genetic Association with Kidney Aging

Our genomic convergence approach identified 103 genes that show age-related changes in expression in the kidney and that also contain eSNPs, indicating a presence of functional polymorphisms. We used these genes as candidates in a gene association study of normal kidney aging. We genotyped a total of 2047 SNPs within these 103 genes in two different cohorts selected to study normal aging. In these studies, the function of the kidney was measured by glomerular filtration rate (GFR) using 24-hour creatinine clearance. The first cohort was the Baltimore Longitudinal Study of Aging (BLSA), which is a long-running study of human aging begun in 1958 (Lindeman R D, Tobin J D, Shock N W (1984) Association between blood pressure and the rate of decline in renal function with age, Kidney Int 26:861-868). This study enlisted 1066 healthy volunteers from the Baltimore area for clinical evaluations of many age-related traits and diseases. GFR was measured at multiple ages for each individual, with an average of 3-4 measurements per individual taken at different times spanning decades. Thus, this study shows not only the average level of kidney function with respect to age, but also shows the age-related downward trend in kidney function for each individual.

The second cohort is the InCHIANTI study, which is a population-based epidemiological study aimed at measuring factors important for aging in the older population living in the Chianti region of Tuscany, Italy (Ferrucci L, Bandinelli S, Benvenuti E, Di lorio A, Macchi C, et al. (2000) Subsystems contributing to the decline in ability to walk: bridging the gap between epidemiology and geriatric practice in the InCHIANTI study, J Am Geriatr Soc 48: 1618-1625). About 90% of the elderly from two towns participated in this study, making it an exceptionally useful source to study genetic determinants of normal aging. GFR measurements were performed at one age in 1130 individuals. Characteristics of both cohorts are shown in Table 3, below:

TABLE 3
Characteristics of kidney aging study samples.

| | BLSA | InCHIANTI |
|---|---|---|
| | Mean (SD) or n | Mean (SD) or n |
| Age | 57.6 (17.1) | 68.4 (15.5) |
| Date of Birth | 1932 (13.5) | 1931 (15.5) |
| No. Subjects | 1066 | 1130 |
| No. GFR measurements per subject | 3.4 (2.6) | 1 (0) |
| No. Male datapoints | 2313 | 515 |
| No. Female datapoints | 1359 | 615 |
| 24-hour Creatinine Clearance | 112.9 (42.4) | 82.4 (30.2) |

We used regression models to test the SNP genotypes in each population for association with GFR (See Methods, below). In order for an allelic association with GFR to be considered significant, we first required evidence of association in both populations (p<0.05 in each population). A total of 13 genes contained SNPs that met these criteria, shown in Table 4, below:

TABLE 4
Top SNPs that show association with kidney aging in two populations.

| | | | | | Fisher's | |
|---|---|---|---|---|---|---|
| Gene | SNP | Model | BLSA P | InCHIANTI P | Meta P* | Permuted P |
| MMP20 | rs1711437 | DOM | 0.0017 | 0.0015 | 3.6 × 10⁻⁵ | 1.0 × 10⁻² |
| IGF1R | rs11630259 | REC | 0.0001 | 0.0443 | 7.8 × 10⁻⁵ | NS |
| RGS6 | rs8007684 | ADD × AGE | 0.0165 | 0.0009 | 1.9 × 10⁻⁴ | NS |
| FAM83F | rs3021274 | DOM × AGE | 0.0063 | 0.0234 | 1.4 × 10⁻³ | NS |
| MMP25 | rs1004792 | REC × AGE | 0.0038 | 0.0427 | 1.6 × 10⁻³ | NS |
| ADCY1 | rs11766192 | REC × AGE | 0.0352 | 0.0054 | 1.8 × 10⁻³ | NS |
| ADAMTS5 | rs10482979 | REC | 0.0169 | 0.0211 | 3.2 × 10⁻³ | NS |
| GPC5 | rs342693 | REC × AGE | 0.0325 | 0.0149 | 4.2 × 10⁻³ | NS |
| MTR | rs2275568 | ADD | 0.0286 | 0.0319 | 7.3 × 10⁻³ | NS |
| RPL15 | rs2360610 | DOM | 0.0469 | 0.0226 | 8.3 × 10⁻³ | NS |
| GLRB | rs17035648 | DOM × AGE | 0.0252 | 0.0474 | 9.2 × 10⁻³ | NS |
| GPC6 | rs4612931 | DOM × AGE | 0.0496 | 0.0270 | 1.0 × 10⁻² | NS |
| SOHLH2 | rs9593921 | DOM × AGE | 0.0380 | 0.0419 | 1.2 × 10⁻² | NS |

*Calculated only if individual p-values from each population were <0.05

Next, we combined these p-values using Fisher's meta analysis, a method for combining p-values from independent tests with the same overall hypothesis (Fisher R A (1948) Combining independent tests of significance, American Statistician 2:1). To correct for multiple hypothesis testing, we performed 1000 permutations of each model by swapping identification labels and keeping the genotypes together to preserve linkage disequilibrium (See Methods, below). Two linked SNPs (rs1711437 and rs1784418) in matrix metalloproteinase 20 (MMP20) remained significant after permutation testing (uncorrected p<5×10, corrected p=0.01).

We considered whether associations found in the BLSA cohort could have been due to population structure. Concern for population structure was minimal in the InCHIANTI cohort because it is a homogeneous Italian population. Most of the BLSA cohort is made of Caucasian individuals (84%). Our mixed-effect regression model included a covariate for self-reported race, which should control for differences due to population structure. In addition, we found that rs1711437 in MMP20 showed an association with kidney aging using only data from self reported Caucasians in the BLSA cohort (uncorrected p=0.0010). These results indicate that the MMP20 SNPs associate with kidney aging per se, and are not artifacts arising from genetic differences between races.

A SNP in the insulin-like growth factor 1 receptor gene (IGF1R) was strongly associated with GFR in the meta-analysis (rs11630259, p=7.8×10⁻⁵, Table 4, above). Decreased activity of this gene has been associated with longer lifespan in model organisms and humans (Suh Y, Atzmon G, Cho M O, Hwang D, Liu B, et al. (2008) Functionally Significant Insulin-like Growth Factor I Receptor Mutations in Centenarians, Proc Natl Acad Sci USA 105:3438-3442; Holzenberger M, Dupont J, Ducos B, Leneuve P, Geloen A, et al. (2003) IGF-1 Receptor Regulates Lifespan and Resistance to Oxidative Stress in Mice, Nature 421: 182-187;Kenyon C, Chang J, Gensch E, Rudner A, Tabtiang R (1993) A C. Elegans Mutant that Lives Twice as Long as Wild Type, Nature 366: 461-464). However, SNPs in IGF1R did not remain significant following permutation testing. Therefore, further studies are required to establish a connection between this SNP and kidney aging.

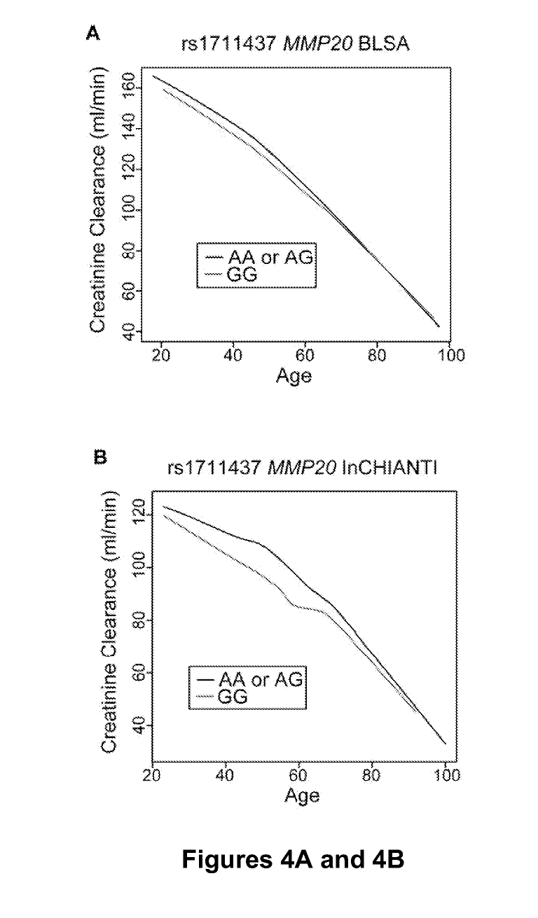

In both populations, one or two copies of the A allele at rs1711437 in MMP20 associated with a higher GFR (FIGS. 4A and B). For an individual who carries the A allele, his or her creatinine clearance is approximately that of someone 4-5 years younger who does not carry the A allele. In the BLSA population, the genotype of rs1711437 explains 2.1% of the variation in creatinine clearance. In the InCHIANTI population, the genotype explains 0.9% of the variation in creatinine clearance. Similar results were found for the second SNP rs1784418 in linkage disequilibrium with rs1711437.

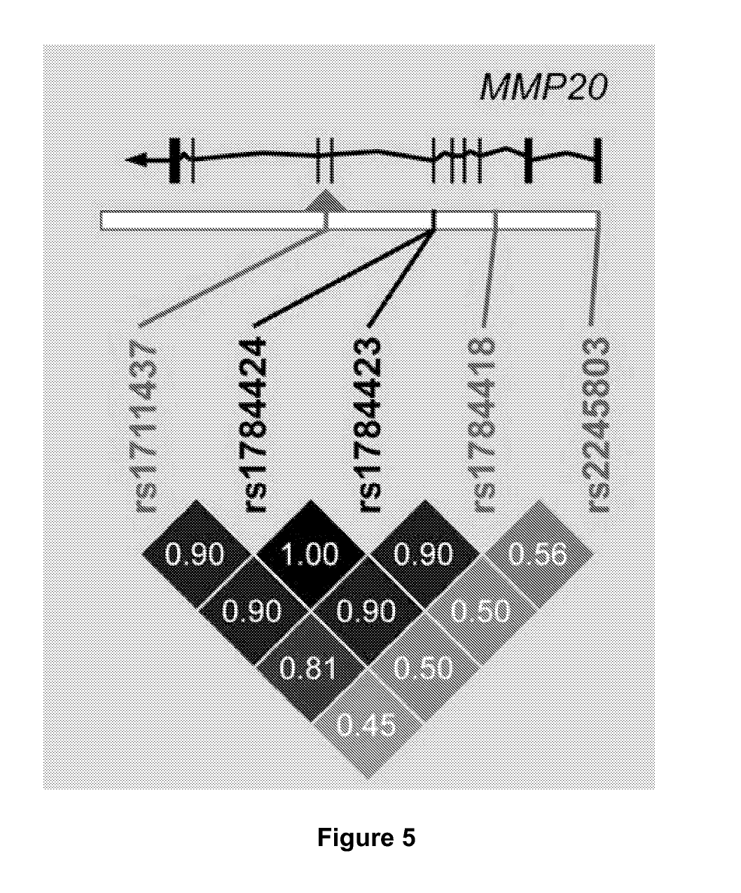

Both rs1711437 and rs1784418 are associated with variation in kidney aging, but the functional SNP is not known. The eSNP rs2245803 identified by allele-specific expression analysis is not linked to rs1711437 and rs1784418 (FIG. 5). Thus, some other SNP in this linkage disequilibrium block, such as a coding SNP or a different eSNP, may cause differences in activity of MMP20 and be responsible for association with the kidney aging phenotype. Interestingly, two nonsynonymous coding SNPs, rs1784424 (Asn281Thr) and rs1784423 (Ala275Val) are contained within this linkage disequilibrium block (FIG. 5). These amino acid differences might affect MMP20 function and these coding changes may be causal for differences in kidney aging among individuals.

The goal of our approach was to converge on genes that influence human kidney aging. We began with a genome-wide transcriptional profile of aging in the human kidney, which gave an unbiased view of gene expression changes that occur with age (Rodwell, et al.). Then, we used total expression analysis and allele-specific expression analysis to determine which alleles are differentially expressed. We identified 103 age-regulated genes whose alleles associated with expression level. SNPs in one of these genes, MMP20, showed a statistically significant association with normal kidney aging. Although significant, the best way to confirm our gene association with renal aging is to replicate the findings in additional populations.

The populations used to identify aging SNPs, BLSA and InCHIANTI, stand out for their usefulness in studying normal kidney aging. Both of these studies were purposefully designed to study healthy individuals, instead of those with diseases associated with old age. The BLSA study includes longitudinal measurements of traits associated with normal aging, which adds considerable power to the analysis.

Two SNPs in MMP20 were significantly associated with age-related decline in GFR of the kidney. Matrix metalloproteinases are involved in the breakdown of the extracellular matrix in normal physiological processes, such as embryonic development, reproduction, and tissue remodeling, as well as in disease processes such as arthritis and metastasis. Matrix metalloproteinases degrade extracellular matrix proteins including laminin, elastin, proteoglycans, fibronectin, and collagens. A role for MMP20 in renal function has not been described before, although previous studies show that MMP20 plays an important role in tooth development. The finding that a matrix metalloproteinase is involved in kidney aging is striking because changes in the extracellular matrix play a key role in aging of the kidney. The glomerular basement membrane thickens, and the mesangial matrix increases in volume with age. Interstitial fibrosis occurs during aging because of an increase in matrix and fibrillar collagen accumulation in the subintimal space.

MMP20 was included in our candidate aging gene set because it is a component of the extracellular matrix, one of the pathways that coordinately show decreased expression with age across three human tissues (Zahn, et al.). Therefore, polymorphisms in MMP20 may not only associate with aging of the kidney, but may associate with phenotypes of aging in other tissues as well. Additionally, if MMP20 is a common regulator of aging, certain alleles may also be enriched in centenarians.

The second-highest scoring gene in our kidney aging association study is the insulin-like growth factor 1 receptor. Although the SNP in this gene did not reach statistical significance in this study, this association is interesting because this gene is part of the insulin-like signaling pathway that has been shown in be involved in aging in worms, flies and mice. Specifically, reduced signaling in this pathway results in longer life spans for these model organisms. In worms, the orthologous gene is called daf-2 (GeneID 175410), and daf-2 mutants can have life spans that are100% longer than wild-type worms. In humans, rare variants in the IGF1R gene in centenarians are associated with reduced IGF1R levels and defective IGF signaling.

Genomic convergence could be used as a general method to increase the statistical power for any human gene association study. Like candidate gene approaches, an advantage of genomic convergence over screening the entire genome is that it increases the statistical power of the gene association study by decreasing the number of SNPs that are tested. An advantage of our genomic convergence approach over a candidate gene approach is that the entire genome was screened for genes that are age-regulated and that contain eSNPs.

Several groups have used DNA microarrays to measure gene expression in lymphoblastoid cell lines and have found polymorphisms that associate with expression level. In a total expression analysis of human brain cortical tissue, 21% of genes have SNPs that associate with expression levels.

Other groups have used the allele-specific expression approach to identify differentially expressed genes in lymphoblastoid cell lines, brain, white blood cells, and the fetal kidney and fetal liver. These studies found that 20-50% of the genes in the genome are differentially expressed. Sixteen of the genes showing allele-specific expression found by our study were also found in previous studies (see Lo, H. S. et al. Genome Res 13, 1855-62 (2003); Milani, L. et al. Genome Res 19, 1-11 (2009); Pant, P. V. et al. Genome Res 16, 331-9 (2006); and Serre, D. et al. PLoS Genet 4, e1000006 (2008). Thus, 79 of the 95 alleles specifically expressed genes identified in this work represent novel findings. Our finding that 42% of tested genes showed allele-specific expression is similar to the percentage found in previous studies.

Of the expression-associated SNPs we identified, most were found using allele-specific expression measurements within heterozygotes. Specifically, 42% of genes contained eSNPs using the allele-specific expression method, whereas only 2% of genes assayed contained eSNPs using the total expression method. The statistical cutoff for finding eSNPs using the allele specific method was more stringent than the one used for the total expression method. Thus, our results may underestimate the improved sensitivity of the allele-specific method over the total expression method

Unlike the total expression method, the allele-specific method examines alleles within the same cellular environment in heterozygous individuals. This maximizes the sensitivity of the assay because the alleles are expressed from the same environment and genetic background. Previous work with a smaller set of 64 genes also showed that allele-specific analysis in heterozygotes was more sensitive than total expression methods for finding SNPs associated with expression levels in cis. The results from the allele-specific analysis demonstrate that differential expression is widespread across the human genome and suggest that differential expression could be a major factor contributing to differences in phenotype among individuals. As the Genotype-Tissue Expression (GTEx) project moves forward, it will be important to consider allele-specific expression data to maximize sensitivity to detect differential expression.

Finding new human aging genes, such as MMP20, contribute to our understanding of the molecular mechanisms underlying the human aging process. Among young individuals, an unfavorable SNP genotype may indicate that they are at risk for rapid decline in kidney function and this information could be extremely useful to identify patients who may require early intervention. Among older individuals, a. favorable SNP genotype may indicate that they may still be eligible as kidney donors even though they may be over the upper age limit. As more aging genes are confirmed, the alleles belonging to a patient can be combined to better predict the aging trajectory of the kidney.

Materials and Methods

Ethical approval for the study was obtained from the Stanford University Institutional Review Board (IRB). All subjects provided written informed consent for the collection of samples and subsequent analysis. This study was conducted according to the principles expressed in the Declaration of Helsinki.

Stanford Kidney Samples: Normal kidney tissue was obtained from Stanford University Medical Center with informed consent either from biopsies of kidneys from transplantation donors or from nephrectomy patients with localized pathology. Kidney tissue from nephrectomy patients was harvested meticulously with the intention of gathering normal tissue uninvolved by the tumor. Samples that showed evidence of pathological involvement or in which there was only tissue in close proximity to the tumor were not used. Kidney sections were immediately frozen on dry ice and stored at 180° C. until use.

RNA and DNA Preparation: Frozen kidney samples were weighed (25-50 mg), cut into small pieces on dry ice, and then placed in 1 ml of TRIzol® Reagent (Invitrogen™, Carlsbad, Calif., United States) for RNA extraction or 600 μl of Buffer RLT Plus™ (Qiagen®, Valencia, Calif., United States) for DNA extraction. The tissue was homogenized using a PowerGen700 homogenizer (Fisher Scientific, Pittsburgh, Pa., United States). Total RNA was isolated according to the TRIzol® Reagent protocol and genomic DNA was isolated according to the Qiagen® AllPrep™ DNA/RNA Mini Kit protocol.

SNP Selection: Candidate aging genes were chosen from previous transcriptional profiling studies and included 447 age-regulated kidney genes (Rodwell, et al.) as well as the genes in the four pathways that are commonly age-regulated in the kidney, muscle and brain: extracellular matrix, ribosome, chloride transport and electron transport chain (Zahn, et al.). The candidate kidney aging genes were first searched for mRNA SNPs that could be used in an allele-specific expression assay. In addition to being within the transcript on an autosome, the SNPs had to have a minor allele frequency greater than 0.05 in the HapMap CEU population, an Illumina® SNP score greater than 0.4, and be greater than 30 by from an exon boundary to ensure the Illumina® genotyping assay would work properly for both genomic DNA and cDNA. For genes that had multiple assayable mRNA SNPs, those closest to the 5′ end of the gene were chosen, with a maximum of two SNPs per gene. These criteria were met for 386 SNPs in 276 genes. For candidate aging genes that did not have an appropriate mRNA SNP, promoter region (defined as 5 kb upstream or downstream of the transcription start site) SNPs meeting the same minor allele frequency (>0.05) and SNP score (>0.4) criteria were chosen. One to four SNPs were chosen per gene for analysis, totaling 1041 promoter SNPs in 354 candidate aging genes.

Genotyping: The candidate aging SNPs were genotyped using a GoldenGate® Custom Panel from Illumina® (San Diego, Calif., United States). Oligonucleotides specific for each allele of each SNP were designed for use in a multiplex PCR. A standard protocol designed by Illumina® and implemented at the Stanford Human Genome Center was used to determine the genotypes of the 96 individuals for whom we had kidney tissue. Samples were hybridized to custom Sentrix® Array Matrices and scanned on the Illumina® BeadStation 500GX. Allele calls were determined using the Illumina® BeadStudio clustering software. The genotyping was successful (>90% call rate, HWE p>0.001) at 1341/1427 of the SNP loci in 599/630 genes (95%). The 1341 SNPs were:

(SNP, Gene) rs10013547, GLRA3; rs1003470, CKAP1; rs10036567, KIAA0141; rs1004792, MMPL1; rs1004792, MMP25; rs1005510, SERPING1; rs1005511, SERPING1; rs10061299, GHR; rs10064298, LOC285636; rs10065570, RPL37; rs10065689, NNT; rs1006629, ZNF6; rs10089, SLC12A2; rs10098470, TPD52; rs10105238, UQCRB; rs1010553, STAB1; rs10119465, RPS6; rs1012352, RPL9; rs10150823, RPS29; rs10153820, TFPI; rs10187622, TFPI; rs10189094, RTN4; rs1019757, NDUFA7; rs1019757, RPS28; rs1020898, RPL10L; rs1023968, TNFRSF11B; rs10276, RARRES1; rs10309, FLRT2; rs10375, BMP7; rs1040, THBS2; rs10403210, NFIX; rs1040350, TSPAN7; rs1041163, VCAM1; rs10417548, HAS1; rs1042122, RPL13A; rs1042823, GPC1; rs1043121, NEBL; rs1043284, RPL27; rs1043298, MMP25; rs1043540, GPR56; rs1043550, CALU; rs10435919, ECM2; rs1043652, PRICKLE1; rs1043784, TXNDC5; rs1044120, NDUFS1; rs1044268, NRP1; rs1044671, SHANK2; rs10447222, RPS14; rs1044782, PGM2L1; rs1045056, AATF; rs1045139, ADAMTS7; rs10456986, KIAA1913; rs10459058, PRB1; rs1046092, CXCL14; rs1046371, FA2H; rs10465818, RPS8; rs10467685, RPL21; rs10470707, ADAMTS9; rs1047662, MTHFD1L; rs1048128, NDUFS6; rs1048155, BHLHB3; rs10488, MMP1; rs10488107, AASS; rs10492487, POLR1D; rs1049471, RPS15A; rs1049476, LAMA2; rs1049524, SLC1A3; rs1049539, SPARCL1; rs10500136, CLCN1; rs10502001, MMP7; rs1050223, COX10; rs10505346, TNFRSF11B; rs10506399, SLC16A7; rs1050646, PTPRO; rs1050779, MMP15; rs1050874, ECM1; rs1050978, NDUFS5; rs1051105, COL15A1; rs10512598, ATP5H; rs1051470, PBP; rs1051827, LOC440993; rs10521009, ADAMTS12; rs10521011, ADAMTS12; rs1052622, ISLR; rs1052651, NTN4; rs1052741, HIBADH; rs1053480, IMPACT; rs1053582, PHLDA3; rs1053592, PHLDA3; rs1054427, RPL36AL; rs1055129, TRIM47; rs1055359, PEG3; rs1056471, HADHB; rs1057902, UBE2Z; rs1058018, UBE2Z; rs1058508, SLC12A7; rs1059611, LPL; rs1060399, COL1A2; rs1061003, MAP4; rs1061237, COL1A1; rs1061375, FBLN2; rs1061947, COL1A1; rs1062394, COL1A2; rs1063119, C10orf56; rs1063499, C7; rs10640, AMT; rs1064875, MMPL1; rs1065314, TIMP3; rs10735031, B4GALNT3; rs10748638, C10orf61; rs10753746, NOS1AP; rs10754339, VTCN1; rs10758143, NDUFS6; rs1076230, ATP5D; rs10768434, MMP26; rs1077971, LHFP; rs10783127, DBT; rs10786230, C10orf61; rs10789400, C1orf173; rs10789859, SDHD; rs1079658, RPN2; rs10800279, NOS1AP; rs10805837, COX7C; rs10810649, BNC2; rs10811175, RPS6; rs10816297, TMEM38B; rs10817193, LTB4DH; rs10840108, RPL27A; rs10856792, MATN3; rs10876481, ATP5G2; rs10883953, SLK; rs10890384, TSPAN1; rs10908826, NDUFS2; rs10921202, RGS1; rs10934, RPL31; rs10962648, BNC2; rs10971028, NDUFB6; rs10987519, RALGPS1; rs11049142, KLHDC5; rs11064498, C1S; rs11071895, RPL4; rs11072518, COX5A; rs11083560, LTBP4; rs11133, PHYH; rs11148, C19orf10; rs11154494, ARHGAP18; rs11171914, ATP5B; rs11214934, NNMT; rs11217125, RPS25; rs1122821, HOMER3; rs1123015, NOS1AP; rs11231664, COX8A; rs1124900, PRKAA2; rs1126478, LTF; rs1127030, RPN1; rs1129304, GLRB; rs1130569, COX6C; rs1132630, PKIB; rs1132635, PKIB; rs1133926, RPL15; rs1136998, LRPPRC; rs1139400, RPL12; rs1147110, MATN3; rs1148422, CKAP4; rs11486966, ASNS; rs11539046, RPL14; rs1154226, LAMA3; rs11545700, RAB34; rs11548188, RAB40C; rs11550784, RPL26L1; rs11556167, PET112L; rs11591185, AK2; rs11596590, C10orf38; rs11632435, AGC1; rs1166, PRELP; rs11672222, HAS1; rs11690047, RPL31; rs11740656, ADAMTS6; rs11741157, CSPG2; rs11746859, CSPG2; rs1175641, CTTNBP2NL; rs11769624, PLOD3; rs11771498, ASNS; rs11893, BTBD11; rs11918289, KNG1; rs11935607, CLCN3; rs11962335, RPL10A; rs12033074, C1QA; rs12084981, NOS1AP; rs12090585, NOS1AP; rs12128727, CHI3L1; rs12144410, ZP4; rs1215597, NUAK1; rs1215599, NUAK1; rs1218960, POLR1D; rs12210123, COL9A1; rs12213388, ARHGAP18; rs12240047, VCAM1; rs12351, RHOBTB3; rs12383, ABCA5; rs1239178, RPL23; rs1239344, OSMR; rs12403834, RPL11; rs12408758, BCAN; rs12409568, VCAM1; rs12426738, NUDT4; rs12436, SERPINE2; rs12436916, RPS29; rs12439, CLIC4; rs12440452, ANXA2; rs12462074, ADAMTS10; rs12493507, RBP1; rs1250229, FN1; rs12545793, RPL30; rs12550827, NDUFB9; rs12567211, NOS1AP; rs12577418, RPS13; rs12589375, NDUFB1; rs12595009, TMED3; rs12597, NUDT4; rs126230, RPL3; rs12636910, CEP70; rs1264899, ATP5F1; rs1267658, RPS17; rs1267659, RPS17; rs12677791, MMP16; rs12689026, BGN; rs12728322, RPL5; rs12734877, C1QB; rs12742817, HAPLN2; rs12756603, C1QB; rs1276282, MMP8; rs1276289, MMP27; rs1277718, MMP12; rs12820834, C1R; rs12886909, NDUFB1; rs12940382, RPL26; rs12946513, RPL26; rs12968, FBLN2; rs12980600, RPS9; rs13044826, PI3; rs13143990, RPL9; rs131445, MMP11; rs131451, MMP11; rs13161583, EBF; rs13190, PIGR; rs1321694, CLCA1; rs132369, EMID1; rs132370, EMID1; rs13255477, RPL30; rs1327118, LEPR; rs13283242, AMBP; rs13294, ECM1; rs13324, NRP1; rs1334145, CLCA2; rs13357703, ADAMTS12; rs13433666, FBLN1; rs13505, VTCN1; rs1359062, RGS1; rs13613, RPLP1; rs1361745, BCAN; rs13642, MPPED2; rs1364722, CLDN1; rs1366410, NNT; rs137625, RPL3; rs1381632, DMP1; rs1382278, MFAP3; rs1385502, TNFRSF11B; rs1385505, TNFRSF11B; rs13900, CCL2; rs13946, COL5A1; rs1396753, TMEM38B; rs13969, MMP9; rs1400178, NDUFB4; rs1403694, KNG1; rs14078, CLCN6; rs1409419, VCAM1; rs14190, C7; rs1425486, PDGFC; rs1427384, TIMP3; rs14324, NOV; rs1445944, ADAMTS6; rs1447011, SETD7; rs1454102, ANXA2; rs1460602, DSG2; rs1461957, SRP9; rs1462369, DMP1; rs1462395, RPL1OL; rs1463478, RPL9; rs1466428, RPL30; rs1468405, URG4; rs1470625, COX5B; rs1473664, NTN1; rs1475106, LTB4DH; rs1476387, SMPD2; rs1478604, THBS1; rs14983, MMPI; rs1512126, COX7B2; rs1512128, COX7B2; rs151358, ATP5E; rs1516454, COL3A1; rs1530803, SPOCK2; rs1535692, GPC6; rs1541341, NDUFA1; rs1541533, RPS13; rs1544130, CLCNKA; rs15477, SPON1; rs1551157, HAS1; rs1558469, AEBP1; rs1564064, RPL10L; rs1567832, RPL27; rs1569498, RPL3; rs1573472, NDUFV3; rs15772, RPP38; rs1583005, NDUFA2; rs15886, ABCA5; rs15915, PLK2; rs15952, GNAS; rs15969, RBM14; rs1608, CRELD2; rs1614188, LAMB4; rs1616965, NDUFA4; rs1621816, KNG1; rs16530, RPL19; rs16537, RPL19; rs1672997, FXYD1; rs1673004, FXYD1; rs1673006, FXYD1; rs16844790, ITGB6; rs16845945, SLC4A10; rs16847548, NOS1AP; rs16850073, CXCL6; rs16851710, PRELP; rs16859613, COX7B2; rs1688002, FXYD1; rs1689512, RPL41; rs16900142, OXCT1; rs16920311, RPS20; rs16920312, RPS20; rs16924899, RPS13; rs16933084, C1S; rs16933827, RPS13; rs16939766, COX4I1; rs16942555, ANXA2; rs16965839, RPL13; rs16969691, WDR61; rs16969707, WDR61; rs1697, RPN1; rs16995284, RPL9; rs16995293, RPL9; rs16995296, RPL9; rs17013285, MEPE; rs17013974, PPM1K; rs17037342, RPL32; rs17040776, ITPR1; rs17046589, RTN4; rs17047146, NDUFB4; rs17047384, NDUFB4; rs17048098, NDUFB4; rs17056569, EBF; rs17059002, KIAA1913; rs17078944, LRRC2; rs17091220, PRICKLE1; rs17102093, RAD54L; rs17129016, COX8C; rs17131285, CTH; rs17135325, PHCA; rs17169191, ASNS; rs17190291, KIAA1913; rs17207321, RPS9; rs17208187, NDUFA2; rs17209627, PELO; rs17213962, OXCT1; rs17245810, TECTA; rs17286758, LRRC2; rs17319250, PLOD3; rs17345759, ASNS; rs17352686, LOX; rs17358566, COL3A1; rs17368814, MMP12; rs17383351, ARHGAP18; rs17389715, COX7A2L; rs17402697, WDR61; rs17413652, UQCRH; rs17431, SSR4; rs17431081, LOX; rs17433222, C1QB; rs1746059, MATN1; rs17476297, COX7C; rs17501108, HGF; rs17505369, NTNG1; rs17510142, RPL9; rs17571004, SRP9; rs17575798, GPR61; rs17599102, GABRA4; rs17627, RPS16; rs17630580, LIX1; rs17633107, THBS1; rs17645969, GPC6; rs17646457, FLRT2; rs17662997, RPL31; rs17663059, RPS15A; rs17670514, HEXB; rs176990, RBP1; rs17718834, EBF; rs17728665, ATP5O; rs17732955, PPM1K; rs1776209, CPEB3; rs17814456, RPS20; rs17814658, RPS20; rs17821546, SULT1C1; rs17827735, GPHN; rs1790994, EMILIN2; rs1794673, NYX; rs1794674, NYX; rs1794675, NYX; rs1800662, NDUFB8; rs1800849, UCP3; rs1801143, DAG1; rs1801257, GPR56; rs1801311, NDUFA6; rs1802061, GSTA4; rs1802212, COX11; rs1802618, COX10; rs1823324, COX5B; rs1851665, KNG1; rs1854797, RPL5; rs1858742, RPS11; rs1861525, CYCS; rs1866389, THBS4; rs1875103, MAP4; rs1875409, AASS; rs1878200, COL3A1; rs1878201, COL3A1; rs1879266, RPL13A; rs1880646, NTN1; rs1881269, C3orf14; rs1882753, CLCA1; rs1885987, SRR; rs1889363, CCNB1IP1; rs1889785, CLCNKA; rs1899, NDUFAF1; rs1920744, DSPG3; rs1920751, DSPG3; rs1920752, DSPG3; rs1923949, RGS1; rs1941404, NNMT; rs1941635, TMPRSS4; rs1943676, RPL17; rs1969513, TMEM92; rs1980307, ATP5J2; rs1982048, AMBP; rs1982049, AMBP; rs1982235, ATP5G3; rs1983649, PI3; rs1983658, COL9A2; rs198411, CLCN6; rs1989983, ABCC3; rs1990548, KERA; rs1997, COX7A2L; rs1998290, COX15; rs2007475, INHBA; rs2009594, CLCNKA; rs2011616, EMILIN1; rs2014453, AEBP1; rs2017583, CLCNKA; rs2025033, DCDC2; rs2028139, RPS27A; rs2032533, ARHGAP18; rs20544, MMP9; rs20566, MATN1; rs2057680, KLHL3; rs2061052, RPL30; rs2067553, RPL35; rs2070706, RBP3; rs2070764, RPL7; rs2070765, PPP1R14B; rs2071221, GLRA1; rs2071229, RPL36A; rs2071387, RBP1; rs2071518, NOV; rs2071520, TNC; rs2072326, STS; rs2072605, CKAP1; rs2073617, TNFRSF11B; rs2073618, TNFRSF11B; rs2073687, RPL27A; rs2074540, RPLPO; rs2074647, RGS6; rs2074986, GFRA1; rs2075520, ZP2; rs2075577, UCP3; rs2075626, NDUFS8; rs2075776, COL9A3; rs2076022, COX6A1; rs2076125, RPL3; rs2096181, FER1L3; rs209923, COL9A2; rs2100432, ANXA2; rs211037, GABRG2; rs213199, RPS18; rs213204, RPS18; rs213207, RPS18; rs2138518, NDUFB4; rs2138533, COL3A1; rs2147318, FAM73A; rs2156430, COL6A2; rs216193, SRR; rs216310, VWF; rs216311, VWF; rs2176252, NDUFB4; rs2180062, FHL1; rs218979, NDUFA4; rs2197414, GABRA6; rs221153, KIAA0644; rs2226834, COL6A2; rs2227260, CKAP1; rs2228253, SP2; rs2228291, CLCN2; rs2229358, SP2; rs2229765, IGF1R; rs2230199, C3; rs2235928, SDHB; rs2236595, ZP4; rs2237051, EGF; rs2239534, WFDC2; rs2239565, ATP5O; rs2239937, CLCN4; rs2240688, PROM1; rs2241591, NDUFA7; rs2241591, RPS28; rs2242128, HAPLN1; rs2242295, MMP19; rs2242589, COL9A1; rs2244175, NNMT; rs2245803, MMP20; rs2247322, RPL12; rs2247392, RPL22; rs2251680, AMBP; rs2252070, MMP13; rs2254177, TMEM92; rs2256292, NNMT; rs2256883, CTTNBP2NL; rs226201, RPS23; rs226380, A2M; rs2267864, PI3; rs2268188, NFYA; rs2268578, LUM; rs2269557, RAB40C; rs2270565, UCP1; rs2270625, RPL37; rs2270756, PELO; rs2271247, TMEM38B; rs2271539, RPL27; rs2271546, AXL; rs2271953, RPL13A; rs2272986, NFYA; rs2274969, RPL35; rs2275984, GGTLA1; rs2277698, TIMP2; rs2277886, EFEMP1; rs2278722, RPL31; rs2278724, RPL31; rs2280214, MFGE8; rs2280231, NDUFS3; rs2280401, RPS11; rs2280495, ADCY1; rs2280578, COX17; rs2281098, CDC42EP1; rs2281636, COX15; rs2281829, C6orf125; rs2282694, OAT; rs2283753, SSR4; rs2286163, NDUFS8; rs2286164, NDUFS8; rs2286268, C7orf23; rs2288393, LOX; rs2288960, ATP5G3; rs2289202, FN1; rs2289202, FN1; rs2289235, ITM2C; rs2292038, RPS27L; rs2292835, UQCRB; rs2293235, COX17; rs2293251, MRAS; rs2294654, PAPPA2; rs2295058, SDHB; rs2295702, COX8C; rs2295781, COX15; rs2296292, LAMC1; rs2296613, NEBL; rs2297834, CLIC5; rs2301637, NDUFA1; rs2301723, RPL6; rs2301759, ATP5D; rs2304524, RPS9; rs2304704, SLC40A1; rs2305600, COL14A1; rs2305819, ITGB6; rs2305998, CHAD; rs2306473, PCSK7; rs2307064, RARRES1; rs2307068, ITPR1; rs2310312, ANXA1; rs2351420, COL3A1; rs2360166, MMP25; rs2360166, MMPL1; rs2365714, HAPLN2; rs2365716, BCAN; rs2376481, GABRG3; rs2376635, RBP3; rs2395507, RPS24; rs240422, COX7A2; rs240423, COX7A2; rs240745, NDUFAB1; rs2412333, ABCC3; rs2425019, MMP24; rs2428982, RPL39; rs2429, COL14A1; rs2429002, RPL39; rs2436514, RPL36; rs2444857, RPL30; rs2444860, RPL30; rs2454217, RALGPS1; rs246905, LOC90355; rs2490232, BCKDHB; rs2490234, BCKDHB; rs2491161, OAT; rs249496, PAM; rs2499958, MMP26; rs2499966, MMP26; rs2511225, DPP3; rs2511990, SERPING1; rs2532689, GFRA1; rs2536512, SOD3; rs254257, NDUFA3; rs254259, NDUFA3; rs254264, NDUFA3; rs255027, ADAMTS2; rs2566, LAMB3; rs2567698, AMBP; rs2576722, RPS27A; rs2578187, ATP5A1; rs2608830, RPL9; rs2615, MATN2; rs2615489, DSPP; rs26232, LOC90355; rs2625288, NFKBIZ; rs2627696, DMP1; rs2627697, DMP1; rs2640569, RPL41; rs2647145, SDHB; rs2647209, SDHB; rs2664581, PI3; rs268230, ATP5G3; rs268231, ATP5G3; rs2729376, SERPING1; rs2733954, COX4I1; rs2734827, UCP3; rs2738, ADAMTS1; rs2748241, RPS14; rs275604, ADAMTS20; rs275605, ADAMTS20; rs275607, ADAMTS20; rs275630, ADAMTS20; rs2760, ANTXR2; rs2761681, OMD; rs277410, LOC285636; rs2795112, ANXA1; rs2795113, ANXA1; rs2795114, ANXA1; rs279700, AASS; rs2808772, COL27A1; rs2808781, COL27A1; rs2809287, ESRRG; rs2816306, RGS1; rs2829887, ATP5J; rs2830581, ADAMTS5; rs2834299, ATP5O; rs2834301, ATP5O; rs2834601, CLIC6; rs2838038, TMPRSS2; rs2839600, NDUFV3; rs2839601, NDUFV3; rs284565, RPL37A; rs284572, RPL37A; rs284573, RPL37A; rs284574, RPL37A; rs284576, RPL37A; rs2845887, FLRT1; rs2847492, NNMT; rs2852427, NNMT; rs2853522, MTR; rs2877098, INHBA; rs2877453, RPL30; rs2887640, UCHL5; rs28899, CSPG2; rs2895219, ECM2; rs290190, SYTL2; rs290193, SYTL2; rs290194, SYTL2; rs290195, SYTL2; rs2904169, DMP1; rs291986, C1QB; rs291988, C1QB; rs292001, C1QA; rs294179, C1QB; rs294180, C1QB; rs2958517, RPL8; rs2976044, RPS20; rs2976045, RPS20; rs2976047, RPS20; rs29761, RPL37; rs3013122, NYX; rs3016865, DKFZP564J0863; rs3020931, BGN; rs3027318, GLRA2; rs3027594, RPL36A; rs304074, ITPR1; rs304077, ITPR1; rs304079, ITPR1; rs3087590, RPL37A; rs3087650, COX11; rs3087660, RPL4; rs3087889, SLC12A2; rs3088121, MATN2; rs308950, TIMP4; rs308953, TIMP4; rs3094291, RPL21; rs3094295, RPL24; rs3098233, CTHRC1; rs3101018, CLIC1; rs3118994, ZNF297B; rs31303, NDUFS4; rs3131383, CLIC1; rs3134068,, TNFRSF11B; rs316234, LIX1; rs3176860, VCAM1; rs3176861, VCAM1; rs3177253, PECI; rs3178292, RPS2; rs318095, ATP5G1; rs3204853, NDUFAF1; rs3208305, LPL; rs3210089, NDUFA9; rs3211189, GSTM4; rs32613, PLK2; rs3291, RGS6; rs333079, AHCYL1; rs33395, ADAMTS6; rs33608, CSPG2; rs3365, RPL27A; rs34869, CDO1; rs34896, RHOBTB3; rs351583, MSR1; rs35195, CDH11; rs35213, CDH11; rs3522, LOXL1; rs367836, GSTA4; rs369880, RPL18; rs3728, BRP44L; rs3731572, LTBP1; rs3733625, EGF; rs3735242, GPC2; rs3735520, HGF; rs3735557, ASNS; rs3738035, SRP9; rs3738476, PRUNE; rs3738637, CLCNKA; rs3739956, ANXA1; rs3742089, C1R; rs3743262, IGF1R; rs3743563, MMP15; rs3743936, MMP25; rs3743936, MMPL1; rs3744017, TRIM47; rs3744811, Cl8orf1; rs3747303, RPS4X; rs3748166, TNC; rs3749376, THRB; rs3750625, ADRA2A; rs3751234, KLHDC5; rs3752536, ARHGAP18; rs3753270, RPL11; rs3753362, UQCRH; rs3754507, SDHB; rs3754734, EMILIN1; rs3755724, TIMP4; rs3757583, ELN; rs3757676, ASNS; rs3758856, MMP13; rs3759222, LUM; rs3759860, TMED3; rs3760841, UQCRFS1; rs3760994, RPS15; rs3761326, ATP5J; rs3761628, GPC4; rs3762991, PELO; rs3763389, DMP1; rs3763979, SLC16A7; rs3764536, RPS5; rs3765460, COL9A3; rs3765975, CLCA2; rs3766810, AK2; rs3768480, AHCYL1; rs3770785, FEZ2; rs3773306, RPL32; rs3778173, RPS12; rs3780591, RPL35; rs3780594, RPL35; rs3781907, UCP3; rs3782699, CKAP4; rs3782928, C1R; rs3784545, TMED3; rs3785408, GGA2; rs3786567, RPL13A; rs3794176, NDUFS8; rs3794664, COX4I1; rs3795727, HAPLN2; rs3796934, RPL34; rs3797040, CLCN3; rs3797041, CLCN3; rs3797622, RPS14; rs3801158, INHBA; rs3805455, GABRP; rs3806235, DBT; rs3806236, DBT; rs3806318, LEPR; rs3806572, RTN4; rs3806988, MUT; rs3808374, RPL8; rs3808831, RPL12; rs3809156, ATP5G2; rs3809566, TPM1; rs3809714, RPL38; rs3810229, RPS9; rs3810329, SYMPK; rs3810631, FBLN1; rs3810632, FBLN1; rs3810635, FBLN1; rs3810738, AMELX; rs3810740, CLCN4; rs3811992, GABRA6; rs3811995, GABRA6; rs3813359, KIAA1913; rs3813360, KIAA1913; rs3813573, CRABP1; rs3813623, NDUFS2; rs3813729, C1R; rs3813730, C1R; rs3814171, RPP38; rs3814888, RPL17; rs3816413, NDUFC1; rs3818532, C6orf125; rs3818815, RPL36; rs3819089, MMP13; rs3819100, NNMT; rs3819332, RPS14; rs3820033, RPL11; rs3820231, SRP9; rs3821608, RPL32; rs3821815, KNG1; rs3822356, NDUFA2; rs3826321, RPL38; rs3826322, RPL38; rs3826439, CHAD; rs3848161, ISLR; rs3848638, NDUFS7; rs3853401, LOX; rs3888004, ISLR; rs3889281, RBMS3; rs3892761, ATP5G2; rs3913009, RPS10; rs3913010, RPS10; rs3914916, RPL39L; rs3917009, VCAM1; rs3922634, SPG7; rs3940746, ANXA2; rs394447, MSR1; rs402007, ADAMTS1; rs409445, RPL26; rs4131364, RPLP2; rs4131826, SDHC; rs414836, MSR1; rs4151667, BF; rs4222, FU20323; rs422679, RPL26; rs4234677, ADAMTS9; rs423490, C3; rs4237000, RPL7; rs423906, THBS4; rs4242592, TNFRSF11B; rs4246111, MMP16; rs4246907, TNC; rs4253963, USH2A; rs4269525, NDUFB9; rs4302292, ATP5O; rs4323773, USH2A; rs4347628, SPG7; rs4392413, ADAMTS9; rs4394387, RPL7; rs4396173, USH2A; rs4402665, RPL17; rs4434205, CLCN3; rs4437091, CLASP2; rs444013, UBD; rs4447076, MMRN2; rs445310, KIAA0141; rs4501743, CLCN4; rs4515601, MMP16; rs4523957, SRR; rs4560384, COX7B2; rs456298, TMPRSS2; rs4571, PET112L; rs4572, TGFBI; rs457947, ADAMTS5; rs4584412, VCAM1; rs4596421, GABRA1; rs459710, CSNK2A1; rs4605, FMOD; rs4625, DAG1; rs463749, RPS18; rs464921, RPS18; rs4653674, SRP9; rs4655, ATP5C1; rs465658, RPS18; rs4663722, COL6A3; rs4670570, FEZ2; rs4679, NDUFA8; rs4680816, RBMS3; rs4686456, RPL39L; rs4688500, ADAMTS9; rs4690362, VEGFC; rs4692572, CLCN3; rs4696658, RPS3A; rs4708055, MTO1; rs472054, CHRNA3; rs4727040, NDUFS2; rs4727378, ASNS; rs4728690, C7orf23; rs4754, SPP1; rs4759282, ATP5G2; rs4764324, GABARAPL1; rs4764327, GABARAPL1; rs4776787, RPL4; rs4790, PCBP2; rs4795089, MMP28; rs4795090, MMP28; rs4796108, MMP28; rs480092, VARS; rs480211, COX8A; rs4802612, RPL13A; rs4802856, HAS1; rs4803934, PPP1R14A; rs4808883, HOMER3; rs482843, CTH; rs4835689, HSPA9B; rs484208, COL9A1; rs4845360, RPS27; rs4865744, PELO; rs4865745, PELO; rs4866399, ADAMTS12; rs4887029, WDR61; rs4889657, COX6A2; rs4905166, FAM14A; rs490574, CTH; rs4908864, RPL22; rs4917407, SLK; rs4926172, NFIX; rs4926176, NFIX; rs4938619, RPS25; rs4938621, RPS25; rs4945191, CLNS1A; rs4950929, CHI3L1; rs4967978, USP31; rs4968014, GGA2; rs4969168, SOCS3; rs4973442, NMUR1; rs499799, NDUFC2; rs501602, ZP4; rs502121, NDUFS7; rs510634, LAMA5; rs521633, RPL19; rs523476, COX17; rs523975, CEP70; rs529615, CEP70; rs534812, RPS3; rs537266, SYTL2; rs540389, COX8A; rs542441, C6orf125; rs546502, PPFIA1; rs553717, GPC5; rs564031, COL9A1; rs5668, PTGER3; rs567, NDUFS4; rs573400, GABRA2; rs573766, SYTL2; rs5757613, RPL3; rs5850, GPNMB; rs5854, MMP1; rs587585, C1QA; rs591043, PHCA; rs5912116, RPS4X; rs5933366, GPC3; rs5934700, STS; rs5958777, RPS4X; rs5963513, TSPAN7; rs597315, MMP13; rs5978265, KAL1; rs5978952, KAL1; rs5978953, KAL1; rs5979395, AMELX; rs5995711, RPL3; rs601071, EMILIN2; rs602128, MMP3; rs6031843, RPN2; rs6032040, PI3; rs6032213, WFDC2; rs6042672, FLRT3; rs6060399, COX4I2; rs6060403, COX4I2; rs6061230, LAMA5; rs6070698, ATP5E; rs6073993, SLC12A5; rs6119610, COX4I2; rs6121396, RPS21; rs6121558, RPS21; rs6122316, COL9A3; rs614201, ADAMTS14; rs621601, NDUFB6; rs629566, NDUFB6; rs632603, FLRT1; rs6366, NDUFB10; rs6366, RPS2; rs638227, FLRT1; rs638775, TECTA; rs640198, MMP13; rs641153, BF; rs6417829, TSPAN7; rs6438542, COX17; rs6443038, NDUFB4; rs644396, PPFIA1; rs6444202, RPL39L; rs6450080, PELO; rs6460055, CLDN3; rs6464541, CLCN1; rs6465630, ASNS; rs648743, CTH; rs6489746, WNK1; rs6495287, WDR61; rs650241, SERPINH1; rs650275, VSNL1; rs6520277, TIMP1; rs6526113, GABRA3; rs6530946, MSR1; rs6531718, RPL9; rs653790, NDUFB6; rs6588640, PRKAA2; rs659383, MMP13; rs659822, LAMA5; rs660339, UCP2; rs660652, CHRNA3; rs661246, Cllorf9; rs6627595, GABRA3; rs663214, MFAP1; rs663465, CTH; rs6643794, SSR4; rs6656063, KIRREL; rs665691, C1QA; rs6660701, NOS1AP; rs6660919, AK2; rs6695928, UAP1; rs6698204, CHI3L1; rs6700594, SDHB; rs6702936, NOS1AP; rs6704, SERPINH1; rs6704428, UAP1; rs6737, NDUFA5; rs6750, POSTN; rs675392, MMP13; rs6755468, RTN4; rs6759549, RPS7; rs677688, IMPACT; rs678376, SYTL2; rs6788514, NDUFB4; rs6789298, ADAMTS9; rs6791696, RPL24; rs6797522, NFKBIZ; rs681475, CTH; rs6816703, NDUFC1; rs6822, NDUFA8; rs6833256, GABRG1; rs6843792, TBC1D9; rs6853616, TBC1D9; rs685523, ADAMTS13; rs6859808, EBF; rs686364, CLDN8; rs6869244, EBF; rs6871, ISOC1; rs6883877, GABRA1; rs6898906, PCDHA1; rs6900, RAFTLIN; rs690216, RAFTLIN; rs6904263, GMNN; rs6916646, COL9A1; rs6926466, RPS12; rs6927593, KIAA1913; rs6928110, KIAA1913; rs693420, ZP4; rs694609, POLR1D; rs6962852, CLCN1; rs696703, Clorf173; rs6977581, LOC155060; rs6993, GOT2; rs702398, NDUFA2; rs7030031, TNC; rs7035109, LTB4DH; rs705423, LOC283537; rs705704, RPS26; rs706308, SETD7; rs706310, SETD7; rs7071351,RPS24; rs7095992, ADAMTS14; rs7097, POLR1D; rs7097109, SLK; rs7111860, LOC387758; rs7125607, RPS13; rs7131534, RPS25; rs7135965, LDHB; rs7140961, CCNB1IP1; rs7141379, NDUFB1; rs7151932, NDUFB1; rs7177445, FBN1; rs7196121, UQCRC2; rs7201, MMP2; rs7218002, NTN1; rs7219464, RPL38; rs7219493, ATP5H; rs7228550, ATP5A1; rs7229278, RPL17; rs7245, NDUFA6; rs7249094, ADAMTS10; rs7255648, RPL28; rs7255657, RPL28; rs725584, FHL1; rs7297602, ATP5G2; rs730079, COMP; rs7307, SPOCK2; rs734379, RPS5; rs7359861, COX6B1; rs736911, CHAD; rs7373686, SCN5A; rs7373934, SCN5A; rs738331, RPL3; rs738791, MMP11; rs7391474, GABRA3; rs740252, KIAA0644; rs7403021, GABRG3; rs7404739, USP31; rs740580, NDUFB10; rs740580, RPS2; rs7441, DCN; rs7447732, EBF; rs7450, MAK10; rs747948, RPS21; rs747949, RPS21; rs750449, FBLN1; rs7508025, RPL18A; rs7515776, CHI3L1; rs753279, NDUFA2; rs753280, NDUFA2; rs753420, COX7A1; rs7536272, TSPAN1; rs755726, RPS21; rs7560321, FEZ2; rs7561, LAMB1; rs7569, LTBP2; rs757421, ABCC3; rs7576918, ANTXR1; rs757961, C7orf23; rs758335, NDUFB10; rs758335, RPS2; rs7584385, ANTXR1; rs7593881, VSNL1; rs759628, UQCRFS1; rs7617901, RPL32; rs7627602, RPL32; rs7631002, RPL35A; rs7646, MTHFD1L; rs765320, ANXA2; rs7659772, GLRA3; rs7678338, GABRA4; rs7683552, COX7B2; rs769099, ITPR1; rs769395, GAD1; rs7704209, GABRA6; rs770895, TPBG; rs770911, TPBG; rs7716758, PELO; rs7728482, OXCT1; rs7747, ANTXR2; rs7750700, MUT; rs7768, PRDX3; rs778591, NDUFA2; rs7790127, ASNS; rs7803697, NDUFB2; rs7835845, MMP16; rs7843902, RPL7; rs7867300, OMD; rs7881, POLE4; rs7885457, CLCN5; rs7885997, RPL39; rs788908, ADAMTS3; rs7894615, DHTKD1; rs7899526, C10orf38; rs7907110, FER1L3; rs7914, MCAM; rs7925000, RPL27A; rs7948073, NDUFV1; rs7962629, C1S; rs7963016, ATP5G2; rs7965055, C1S; rs7968584, C1S; rs7992315, F1138725; rs8025779, CYFIP1; rs8026257, WDR61; rs8028537, AGC1; rs8033800, ANXA2; rs8042694, COX5A; rs8043062, RPL4; rs805701, COL17A1; rs8067, ASPN; rs8070845, RPL38; rs8071689, RPL26; rs8089, THBS2; rs8089150, ATP5A1; rs8095608, ATP5A1; rs8103278, SYMPK; rs8109226, PALM; rs8109749, UQCRFS1; rs8112223, HAS1; rs8122715, RPN2; rs8133991, ATP5J; rs8169, DKK3; rs8204, ALDH6A1; rs820870, HEXB; rs820879, HEXB; rs820880, HEXB; rs820883, HEXB; rs8298, CLDN1; rs831592, FBXO3; rs834504, VSNL1; rs840462, LOX; rs840464, LOX; rs8471, PGM2L1; rs8530, MFGE8; rs8597, CALU; rs8643, TXNDC5; rs867131, GGA2; rs868005, ELN; rs869457, LAMC3; rs8699, NTN4; rs876252, ATP5G2; rs876663, RPL35; rs8818, LOXL1; rs884368, CCNB1IP1; rs8914, ARHGAP1; rs8924, TMPRSS4; rs892940, THRB; rs893971, PPM1K; rs894469, FM05; rs9037, MAP4K3; rs906807, NDUFV2; rs908803, DEGS1; rs908804, DEGS1; rs9131, CXCL2; rs913243, C1QB; rs9138, SPP1; rs915941, RPL10; rs915942, RPL10; rs915943, RPL10; rs916863, KLHL3; rs917183, HGF; rs922901, NDUFA4; rs923118, ISLR; rs923118, ISLR; rs923370, RPL23; rs9252, PTRF; rs9254, COL6A1; rs9259, CLIC4; rs928501, CTGF; rs929762, GABRP; rs929881, FA2H; rs9308843, RPL31; rs9310411, RPL32; rs9325510, SLK; rs9341423, MTO1; rs9352801, BCKDHB; rs9371, DLAT; rs9389034, RPS12; rs9399005, CTGF; rs9402163, ARHGAP18; rs940853, NTN1; rs9425, COL17A1; rs9429768, AHCYL1; rs945425, CLCNKA; rs946252, AMELX; rs946259, CHI3L1; rs946261, CHI3L1; rs9501975, C6orf85; rs952561, GLRA3; rs953978, RPS27L; rs957, RPS6; rs958187, FAM14A; rs959, PTGER3; rs960816, COL9A1; rs962066, CSPG2; rs9660, ATP5H; rs966627, LTB4DH; rs966628, LTB4DH; rs968474, COX6A1; rs969, ZA20D2; rs973447, WFDC2; rs9779, MTR; rs981829, RBMS3; rs981830, RBMS3; rs9821102, RBMS3; rs9822, DLAT; rs9829395, NDUFB5; rs9841857, NFKBIZ; rs9858528, KLHL24; rs9865039, NDUFB4; rs9880989, IQCG; rs9883112, C3orf14; rs9921, CLCN7; rs9933, SPARCL1; rs994004, CSPG2; rs9941555, FEZ2; rs9974298, NDUFV3; rs9978055, COL6A2; rs998664, AK2.

Total Expression Quantification: Most of the microarrays (68 cortex and 59 medulla samples) used in our total expression association study were previously analyzed (Rodwell, et al.). The same Affymetrix® (Santa Clara, Calif., United States) HG-U133A and HG-U133B high-density oligonucleotide arrays used in Rodwell et al. were used here to measure total expression levels in 26 additional cortex samples. The samples were processed at the Stanford Genome Technology Center using their standard protocol (Rodwell, et al.). Eight micrograms of total RNA was used to synthesize cRNA for each sample, and 15 μg of cRNA was hybridized to each microarray. Using the dChip program (Zhong S, Li C, Wong W H (2003) Chipinfo: Software for Extracting Gene Annotation and Gene Ontology Information for Microarray Analysis, Nucleic Acids Res 31:3483-3486), microarray data (.cel files) were normalized according to the stable invariant set, and gene expression values were calculated using a perfect match model. All arrays passed the quality controls set by dChip. The raw microarray data are available at the Stanford Microarray Database (http://smd.stanford.edu).

Ancestry Analysis: Because our kidney tissue samples were from individuals living in the diverse San Francisco Bay Area, we needed to control for population structure. Most of the individuals in our study self reported their ancestry (84/96). Genetic clustering analysis has been shown to correlate highly with self-identified ancestry. To determine the ancestry of the 12 unknown individuals, we used the clustering program STRUCTURE (Pritchard J K, Stephens M, Donnelly P (2000) Inference of population structure using multilocus genotype data, Genetics 155:945-959). We used the genotypes of 839 unlinked SNPs from our 96 samples and from the CEU, YRI, and JPT+CHB HapMap populations in our analysis. Using the STRUCTURE admixture model, we determined our Stanford samples cluster with the greatest probability into three populations, each clustering with one of the HapMap populations. Because most of the Stanford samples were predominantly of Caucasian genetic ancestry and because it is simplest to use a Boolean covariate value in regression analysis when chronological significance of the state (genetic ancestry in this case) is unknown, we chose to divide the individuals into two groups. In the first group we included individuals with an average percent CEU ancestry >75%. This group included 72 individuals. The second group contained the other 24 individuals. The 84 self-reported ancestries matched the ancestries calculated with STRUCTURE.

Total Expression Regression Models: We used a linear regression model to determine which promoter SNP genotypes showed a statistically significant association with gene total expression levels:

Yᵢⱼ=β₀ⱼ+β₁ⱼgᵢⱼ+β₂ⱼageᵢ+β₃ⱼtᵢ+β₄ⱼancᵢ+β₅ⱼsᵢ+εᵢⱼ (1)

In equation 1, Yᵢⱼ is the base 2 logarithm of the expression level for the gene of SNP j in kidney sample i, g,ᵢⱼ is the genotype (0,1,2 for AA, AB, BB) of individual i at SNP j, ageᵢ is the age in years of the individual contributing sample i, tᵢ is 0 if sample i was from kidney cortex and 1 if sample i was from kidney medulla, ancᵢ is 0 if the individual contributing sample i has >75% CEU ancestry and 1 for other ancestry proportions, sᵢ is 0 for males and 1 for females, and εᵢⱼ is a random error term. The coefficients βₖⱼ for k=0−5 were estimated by least squares from the data. Our primary interest was β₁ⱼ values that significantly differed from zero, indicating that SNP j associates with total expression level. Because our microarrays were processed on two different scanners three years apart, we analyzed the two sets of data separately. The first set comprised the 127 samples previously analyzed in Rodwell et al. and the second set comprised the 26 additional samples processed here. We combined the results from the two regression analyses using Fisher's combined probability test. The β₁ⱼ p-values from each of the two analyses were combined into one test statistic (x²) having a chi-square distribution and four degrees of freedom using the formula:

$${χ}^{2} = - 2 {\sum }_{i = 1}^{2} {log}_{e} ( {p}_{i} ) \qquad ( 2 )$$

Using Fisher's method, we found 11 promoter SNPs in seven genes and 5 mRNA SNPs in 5 genes that associated with total expression level (p <0.001).

Allele-Specific Expression Quantification: Total RNA was reverse transcribed into cDNA using the SuperScript® Double-Stranded cDNA Synthesis Kit (Invitrogen®, Carlsbad, Calif., United States). The same Illumina® GoldenGate® Custom Panel used for genotyping was used to measure cDNA levels according to which allele of the SNP is present in the transcript. Only SNPs for which the DNA genotyping was successful were analyzed. After the cDNA PCR products were hybridized and scanned, the raw allelic intensities were first used to determine which transcripts were expressed. The expression threshold was defined by the absent allele in normal homozygotes. That is, for an AA genotype, the intensity of the B allele was taken to be background. The expression threshold was calculated for each SNP as the mean of the background intensity plus two standard deviations. SNPs with five or more heterozygotes showing expression of at least one of the two alleles were carried through the rest of the analysis. Of the SNPs measured, 309 of them in 225 genes were genotyped correctly (call rate >90%, HWE p>0.001) and expressed above a background threshold in at least 5 heterozygotes. To determine which alleles were associated with expression level, a confidence interval was calculated for each SNP using the DNA allele intensities of heterozygotes. The confidence interval for each SNP was defined as the mean of the normalized DNA allele A/B raw intensity ratios plus or minus two standard deviations. If the cDNA allele intensity ratio for more than 50% of individual heterozygotes fell outside the 95% confidence interval and the meta p-value was less than 10⁻⁶, the SNP was considered to be an eSNP. eSNPs were not observed simply due to low, noisy transcript levels because the relative abundance of each gene in the total cDNA sample (calculated from whole-genome microarray data) was greater than the relative abundance of the gene in the genomic DNA sample.

BLSA Samples: The Baltimore Longitudinal Study of Aging (BLSA) is an intramural research program within the National Institute on Aging (Lindeman, et al.). Healthy volunteers aged 18 and older were enrolled in the study starting in 1958. BLSA participants are predominantly Caucasian, community residing volunteers who tend to be well-educated, with above-average income and access to medical care. These subjects visit the Gerontology Research Center at regular intervals for two days of medical, physiological, and psychological testing. Each participant has a health evaluation by a health provider (physician, nurse practitioner, or physician assistant). Currently, the study population has 1450 active participants, aged 18-97 years (http://www.grc.nia.nih.gov/branches/blsa/blsa.htm). The level of kidney function in the participants has been measured longitudinally in each individual between 1 and 16 times over a 10 to 50 year time period. The kidney aging phenotype of glomerular filtration rate (GFR) was measured by calculating creatinine clearance. Specifically, serum creatinine and 24-hour urinary creatinine levels were obtained from participants using standard clinical procedures (need correct reference; #56 does not appear to be correct), and were used to calculate creatinine clearance as follows:

$${C}_{Cr} = \frac{{U}_{Cr} \times {V}_{U}}{{P}_{Cr} \times 1440} \qquad ( 3 )$$

where C_{Cr} is creatinine clearance in ml/min, U_{Cr} is urinary creatinine concentration, V_{U} is the volume of urine collected over 24 hours, P_{Cr} is the plasma concentration of creatinine, and 1440 is the number of minutes in 24 hours. We were granted access to genotype and GFR data for 1066 individuals. The genotype data comprised the 2047 SNPs genotyped on the Illumina® HumanHap550 Genotyping BeadChip that are within the 103 genes that contain SNP associations with expression and have minor allele frequencies>0.01 (Table S4). The GFR data included 3672 creatinine clearance measurements.

InCHIANTI Samples: The participants in the InCHIANTI study consist of residents of two small towns in Tuscany, Italy (Ferrucci, et al). The study includes 1320 participants (age range 20-102 yrs), who were randomly selected from the population registry of Greve in Chianti (population 11,709) and Bagno a Ripoli (population 4,704) starting in 1998. Over 90% of the population that were over the age of 65 participated in this study, and thus the cohort is a good representation of normal aging (http://www.inchiantistudy.net). GFR was calculated using creatinine clearance from 24-hour urine collection as in the BLSA study. In this study, the measurement for creatinine clearance was performed at one age only. The genotype data generated by HumanHap550 Genotyping BeadChip consisted of the same 2047 SNPs in 103 candidate aging genes obtained from the BLSA (Table S4). The sample size was 1130 individuals.

Glomerular Filtration Rate Regression Models: Due to the longitudinal nature of the BLSA data, we used a mixed-effect regression analysis to search for SNP associations with creatinine clearance. Because the creatinine clearance measurements within one subject over time are correlated, the regression coefficients are allowed to vary between individuals. First, we developed the following model using a likelihood ratio approach to explain how creatinine clearance changes with time:

Yᵢₐ=β₀ᵢ+β₁ᵢaᵢ+β₂ᵢaᵢ²+β₃ᵢdᵢₐ+β₄ᵢdᵢ²+β₅ᵢsᵢ+β₆ᵢrᵢ+εᵢₐ (4)

In equation 4, Yᵢₐ is the creatinine clearance of subject i at age a, aᵢ is the age of subject i, dᵢₐ is the date in decimal years of the visit of subject i at age a, sᵢ is the sex of subject i, rᵢ is the self-reported race of subject i, and εᵢₐ is a random error term. Most of the data points (84%) came from self-reported Caucasian individuals. These individuals were coded 0 for the rᵢ term and everyone else was coded 1. The coefficients βₖᵢ of each subject i for k=0-6 were estimated by maximum likelihood from the data using the “1mer” function from the “1me4” package of R version 2.8.0. Next, to determine if the genotype of any of our candidate aging genes can account for some of the variance in creatinine clearance, we added two terms to the model:

$${Y}_{ia} = {β}_{0 ij} + {β}_{1 ij} {a}_{i} + {β}_{2 ij} {a}_{i}^{2} + {β}_{3 ij} {d}_{ia} + {β}_{4 ij} {d}_{i}^{2} + {β}_{5 ij} {s}_{i} + {β}_{6 ij} {r}_{i} + {β}_{7 ij} {g}_{ij} + {β}_{8 ij} ( {g}_{ij} \times {a}_{i} ) + {ɛ}_{ija} \qquad ( 5 )$$

In equation 5, gᵢⱼ is the genotype of SNP j in subject i. We obtained estimates for three different inheritance models: additive, recessive and dominant. In the additive model g is 0, 1, or 2 for homozygous dominant, heterozygous, and homozygous recessive genotypes, respectively. In the recessive model, g is 0 for the homozygous dominant and heterozygous genotypes and g is 1 for the homozygous recessive genotype. In the dominant model, g is 0 for the homozygous dominant genotype and g is 1 for the heterozygous and homozygous recessive genotypes. For each SNP and each inheritance model, we compared the results from equation 5 to the results from equation 4 using a likelihood ratio test to generate a p-value for each SNP. Even though we included a self-reported race term in our models, we also confirmed the rs1711437 association with GFR by analyzing only the data points from Caucasian individuals (p=0.0010). For the InCHIANTI data, because the data are not longitudinal we used a simple linear regression model to search for SNP associations with creatinine clearance. We tested the three inheritance models for SNP association with creatinine clearance at every age (equation 6) and for SNP association with the rate of creatinine clearance decline with age (equation 7):

Yᵢ=β₀ⱼ+β₁ⱼgᵢⱼ+β₂ⱼaᵢ+β₃ⱼsᵢ+εᵢⱼ (6)

Yᵢ=β₀ⱼ+β₁ⱼgᵢⱼ+β₂ⱼaᵢ+β₃ⱼ(gᵢⱼ×aᵢ)+β₄ⱼsᵢ+εᵢⱼ (7)

In equations 6 and 7, Yᵢ is the creatinine clearance of subject i, gᵢⱼ is the genotype of subject i at SNP j, aᵢ is the age of subject i, sᵢ is the sex of subject i, and εᵢⱼ is a random error term. The coefficients were estimated by least squares from the data. In equation 6, our primary interest was β₁ⱼ values that significantly differed from zero, indicating that SNP j associates with creatinine clearance at every age. In equation 7, our primary interest was β₃ⱼ values that significantly differed from zero, indicating that SNP j associates with the rate of creatinine clearance decline with age.

Testing for Evidence of SNP Association with GFR in Both Datasets: In order to be confident of a SNP association with GFR, we required the SNP to show evidence of association in both the BLSA and InCHIANTI populations. That is, we combined the p-values from the BLSA and InCHIANTI data using Fisher's method (equation 2) only if the individual p-values for a particular SNP and inheritance model in each population were both less than 0.05. We used the p-value from the likelihood ratio test for the BLSA data and the p-value from the β₁ⱼ estimate from equation 6 or the β₃ⱼ estimate from equation 7 for the InCHIANTI data to calculate the meta p-value.

Permutation Analysis: To correct for multiple hypothesis testing, we performed permutations to test how often our results could appear by chance. We resampled the data for each population and each model 1000 times, keeping the genotypes together, but swapping the sample labels. The creatinine clearance, time, date, age, and sex information remained together, but the 2011 SNP genotypes connected to each individual were changed in each permutation. Therefore, only the phenotype-genotype relationship was altered by permutation, as the linkage disequilibrium patterns between SNPs remained the same. For each permutation, we calculated Fisher's meta p-values only when both individual p-values from each population were less than 0.05, as we did in the observed data. Then, for each model, we determined how many of the permutations met or exceeded the number of SNPs we found in the observed data at various thresholds. The permuted p-value was the number of permutations that met these criteria divided by 1000. Permuted p-values less than 0.05 were considered significant.

What is claimed is:

1. A method for assessing physiological age of a kidney sample from a human subject, the method comprising:
determining the genetic polymorphism of a set of genes set forth in Table 2 from a kidney sample obtained from said subject to generate an age signature dataset for said sample;
comparing said age signature with a control age signature; wherein a statistically significant match with a positive control or a statistically significant difference from a negative control is indicative of age in said sample.

2. The method according to claim 1, wherein said dataset comprises polymorphism data from a single nucleotide polymorphism set forth in Table 4.

3. The method according to claim 2, wherein said single nucleotide polymorphism is in the MMP20 gene (GeneID 9313).

4. The method according to claim 2, wherein said single nucleotide polymorphism is rs1711437 in MMP20 (GeneID 9313).

5. A method for assessing physiological age of a kidney sample from a human subject, the method comprising:
determining expression information of a set of genes set forth in Table 2 from a kidney sample obtained from said subject, and using said expression information to generate an age signature dataset for said sample;
comparing said age signature with a control age signature; wherein a statistically significant match with a positive control or a statistically significant difference from a negative control is indicative of age in said sample.

6. The method according to claim 5, wherein said dataset comprises quantitative data for the presence of at least ten of said markers.

7. The method according to claim 6, wherein said dataset is subjected to non-supervised hierarchical clustering to reveal relationships among profiles.

8. The method according to claim 5, wherein said sample is exposed to a candidate agent for modulation of aging prior to said determining expression information.

9. The method according to claim 5, wherein said subject is provided with a therapeutic regimen prior to said determining expression information, and wherein said detection provides for an analysis of efficacy of said therapeutic regimen.

10. The method according to claim 5, wherein said therapeutic regimen comprises administration of a candidate therapeutic agent.

11. The method according to claim 9, further comprises determining a plurality of said expression information over a period of time following said therapeutic regimen.

12. The method according to claim 5, wherein said obtaining determining expression information comprises:
extracting mRNA or protein from cells in said sample;
quantitating the level of mRNA.

13. The method according to claim 12, wherein said mRNA is amplified.

14. The method according to claim 5, wherein said determining expression information comprises allele-specific expression methods.

15. The method according to claim 5, wherein said dataset further comprises determination of a genetic polymorphism of a single nucleotide polymorphism as set forth in Table 4.

16. The method according to claim 15, wherein said single nucleotide polymorphism is in the MMP20 gene (GeneID 9313).

17. The method according to claim 15, wherein said single nucleotide polymorphism is rs1711437 in MMP20 (GeneID 9313).

18. A kit for determining assessing physiological age of a kidney in a subject, the kit comprising:
a set of primers or microarray specific for at least 10 genes as set forth in Table 2; and
instructions for use.

19. The kit according to claim 18, further comprising a software package for statistical analysis of expression profiles.
